(19) United States
(12) Patent Application Publication
(10) Pub. No.: US 2013/0164727 A1
(43) Pub. Date: Jun. 27, 2013

(54) DEVICE AND METHOD FOR REINFORCED PROGRAMMED LEARNING

(71) Applicant: Zeljko Dzakula, San Diego, CA (US)

(72) Inventor: Zeljko Dzakula, San Diego, CA (US)

(21) Appl. No.: 13/688,557

(22) Filed: Nov. 29, 2012

Related U.S. Application Data
(60) Provisional application No. 61/565,031, filed on Nov. 30, 2011.

(51) Int. Cl. G09B 7/00

(52) U.S. Cl. CPC G09B 7/00
USPC 434/362

(57) ABSTRACT

A method for reinforced programmed learning to enhance human acquisition of knowledge and skills which includes a step of providing an electronic device for reinforced learning arranged for electronic interaction with a student. On the electronic device for reinforced learning contains at least one database including course templates of preselected education information organized for at least partial retrieval in accordance prearranged course instances. An access information may be arranged to enable the electronic interaction between the electronic device and the at least one student, and storing information pertinent to the at least one student such that the at least one student may select the at least one of prearranged course instances and participate in interactive processing of the preselected education information.

### CROSS REFERENCE TO RELATED APPLICATIONS

This application is based upon and claims priority under 35 U.S.C. 119(e) to U.S. Provisional Patent Application no, 61/565,031 filed Nov. 30, 2011, entitled “DEVICE AND METHOD FOR REINFORCED PROGRAMMED LEARNING” which is herein incorporated by reference in its entirety.

### BACKGROUND

The present, invention applies the concepts of supervised and unsupervised reinforced programmed learning to enhance human acquisition of knowledge and skills. It may foe used to insure achievement of desired learning outcomes in a number of academic or non-academic areas, ranging (but not limited to) from music theory to mathematics, physics, computer science, biology, and/or engineering.

The invention starts from the premise that the success of the learning process is quantified by the increase in the student's skill in solving problems. To enhance the process, the proposed device presents the student with problems of gradually increasing difficulty and, depending on the student's performance, provides hints guiding the student toward correct solutions.

The learning process facilitated by the present invention is reinforced because the proposed device interacts with the student, processing the student's solutions to problems and offering feedback. Unsuccessful attempts to solve a problem are rectified until the student provides the correct solution. Successful answers are rewarded and followed by problems of increasing difficulty. The student may review previously covered material.

The learning process facilitated by the present invention is programmed because the material from the subject area and the problems reinforcing its learning are both pre-planned and stored in the device, while the interactions between the student and the device are automated.

The programmed aspect of the device takes full advantage of currently available capabilities of graphical user interfaces and multimedia to actively engage the student and to enliven the student's learning experience.

While its main purpose is assisting the student in achieving his/her learning goals, some embodiments of the presently proposed device/method also assist the instructor in coordinating the student's learning process, grading, and correcting it.

One way to acquire solid understanding of music theory and to build practically applicable skills in the areas of harmony and counterpoint is through drills. Generating a large enough set of problems and grading students' answers to those problems typically consumes a large fraction of the instructor's time. The present invention automates both tasks, freeing the instructor from the repetitive work and enabling him to devote more time to explaining topics and helping students better understand the material.

Another approach may address the aforementioned problem by using Adobe Flex/Flash (http://www.teoria.com/)a combination of Java and Flex/Flash (noteflight), JavaScript or Java applets (coastonline, http://www.emusictheory.com/).

The current invention as in its entirety as well as a majority of pertinent features and capabilities may foe useful in development, implementation, and usage of computer-enabled web-based server-side and client-side tools for online learning of other subjects generally unrelated to music theory. In general, any subject that may be structured and systematized under a particular theoretical network system may foe organized as a set of related online course (or a hierarchical system of courses). For example, templates related to the current inventions including, but not limited to, applications in online courses in the areas of Physics, Mathematics, and Chemistry may be generated. At present, various embodiments of the current invention are implemented in several online courses including: Basic Musicianship, Music Theory I-IV, Counterpoint, Harmony, and Music Theory for Guitarists I-IV.

A plurality of web browsers may enable viewing source codes for many web pages. Although dynamically created, the web pages are constructed in a way that can betray whether they embed the code specific to this invention. In particular, the values of the CODE and CODEBASE attributes of the APPLET, EMBED, and OBJECT tags say indicate infringement of at least one novel feature of the current invention.

### SUMMARY OF THE INVENTION

A method for reinforced programmed learning to enhance human acquisition or knowledge and stills which includes a step of providing an electronic device for reinforced learning arranged for electronic interaction with at least one student. On the electronic device for reinforced learning contains at least one database including at least one course template of preselected education information organised for at least partial retrieval in accordance with at least one prearranged course instance. An access information may be arranged to enable the electronic interaction between the electronic device and the at least one student, and storing information pertinent to the at least one student such that the at least one student may select the at least one of prearranged course instances and participate in interactive processing of the preselected education information. At least one predetermined course instance specific activity to the at least one student and recording the at least one student responsive input into the electronic device for reinforced learning may be also provided. The method generates and stores at least one evaluation of the at least one student responsive input at least on a basis of the at least one student response input, the information pertinent to the at least one student, and the preselected education information. It also, may communicate the at least one evaluation to the at least one student, providing additional evaluation reinforcing information and proceeding to the step d) until the at least one student opts to proceed to an additional activity or decides to terminate the interactive processing of the preselected education information, and process the at least one stored evaluation and generating at least one grade pertinent to the participation of at least one student, and to assist the at least one student in selection of additional prearranged curse instances.

### BRIEF DESCRIPTION OF THE INVENTION

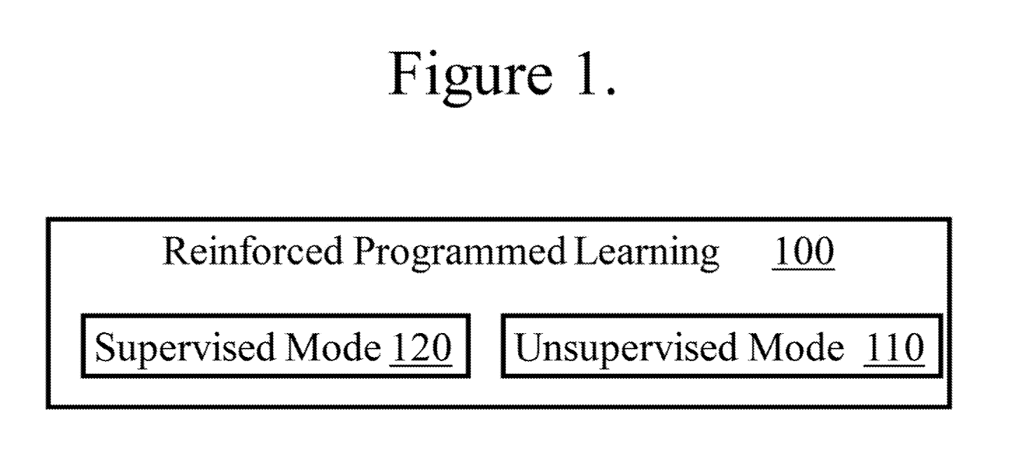

FIG. 1 is an illustration one one embodiment in accordance with the current invention.

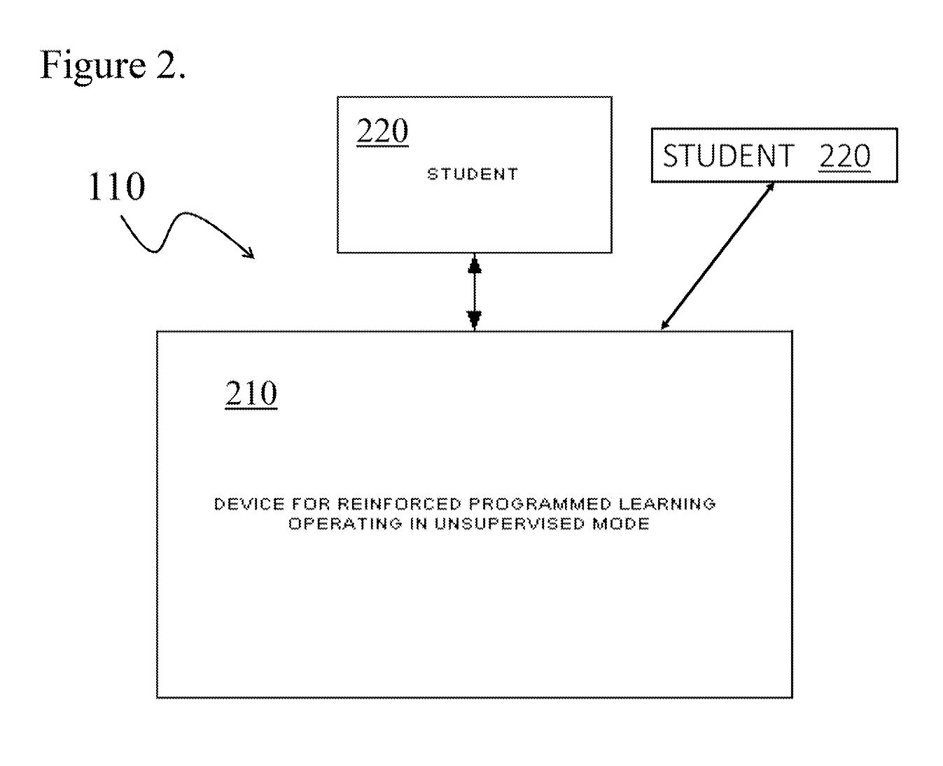

FIG. 2 is an illustration another one embodiment in accordance with the current invention.

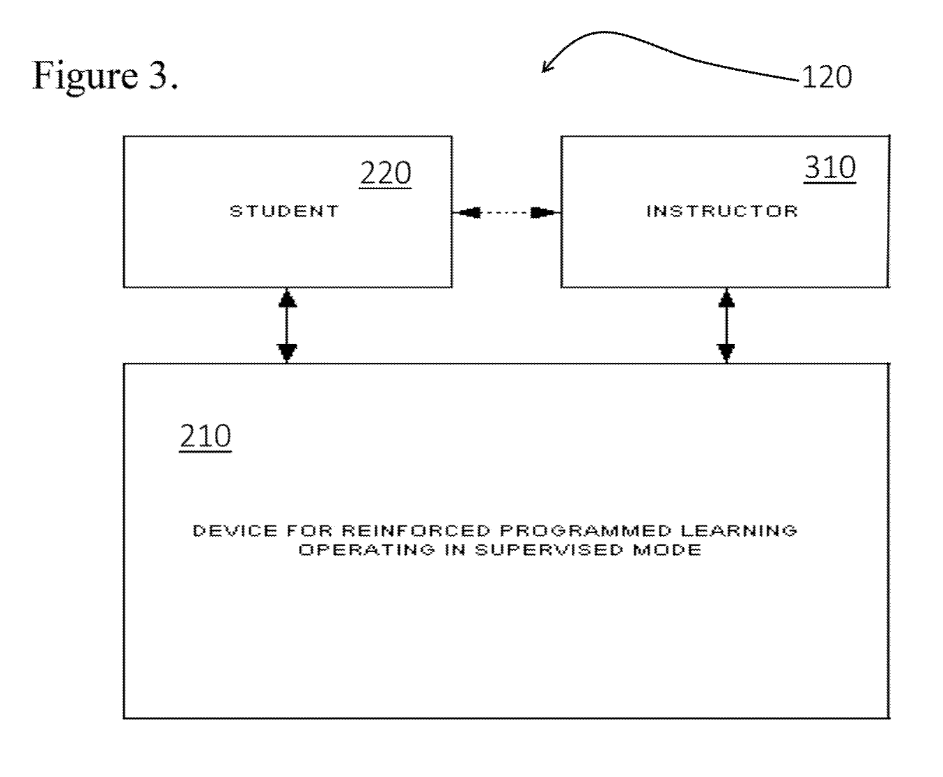

FIG. 3 is an illustration yet another one embodiment in accordance with the current invention.

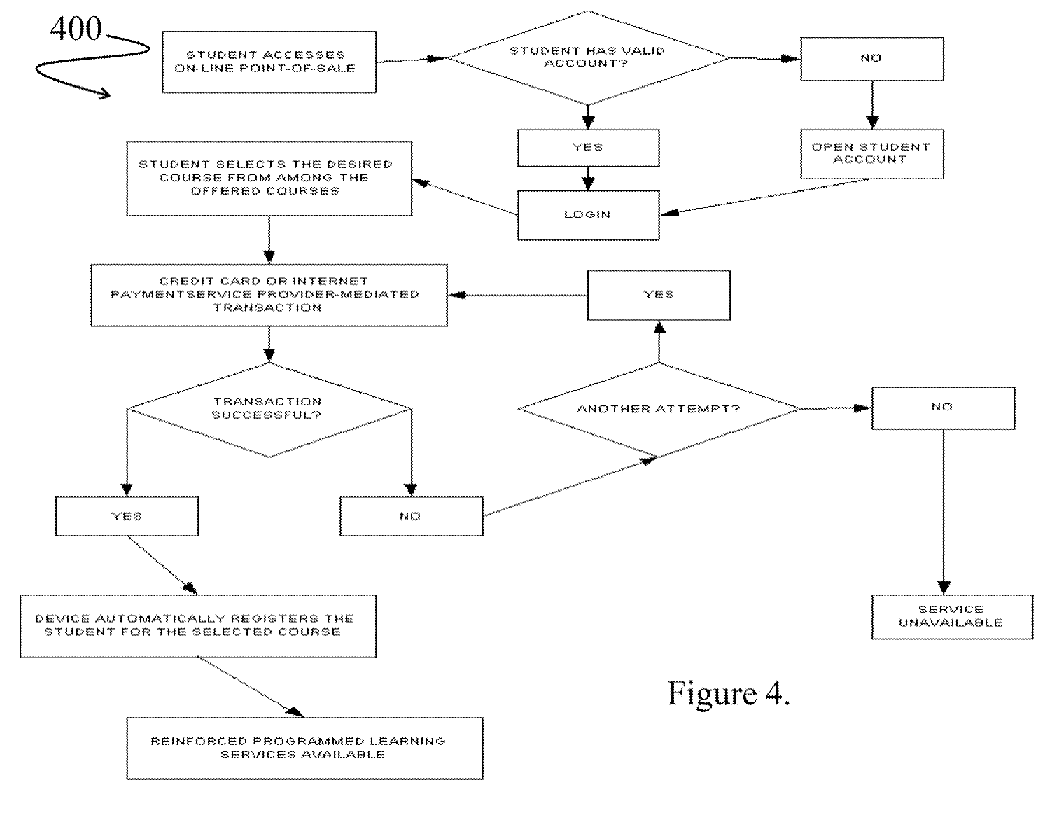

FIG. 4 is an illustration yet another one embodiment in accordance with the current invention.

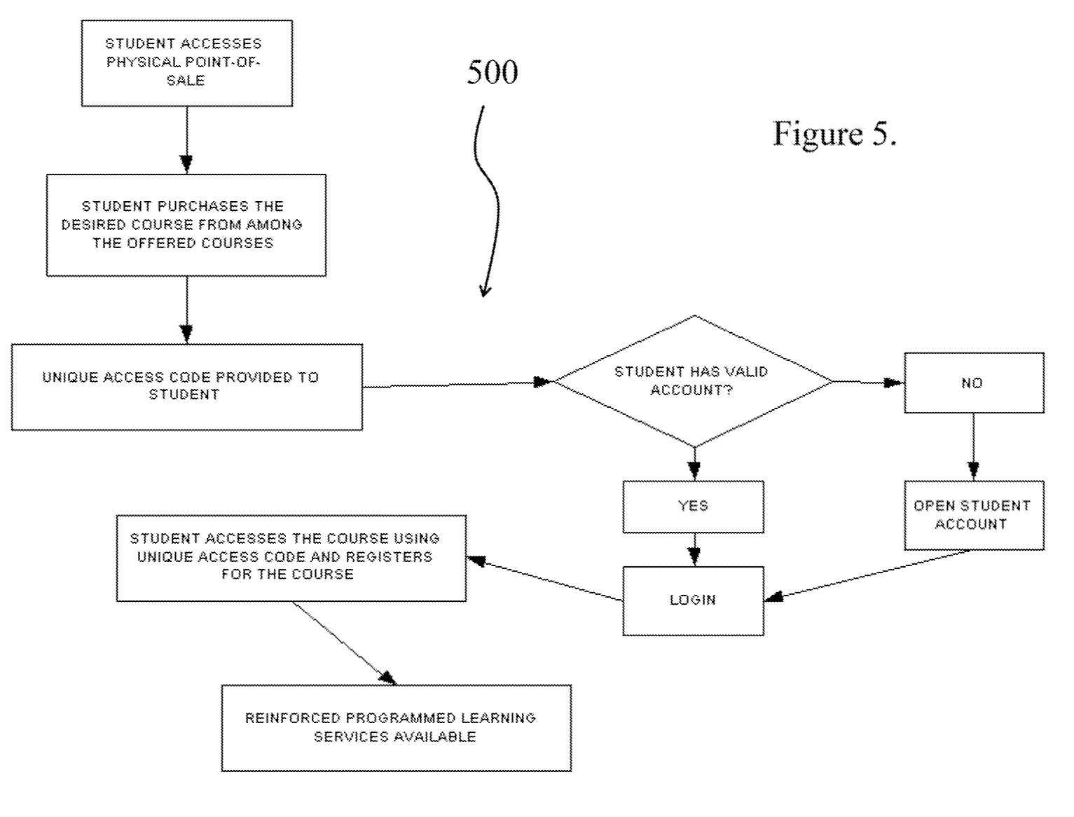

FIG. 5 is an illustration yet another one embodiment in accordance with the current invention.

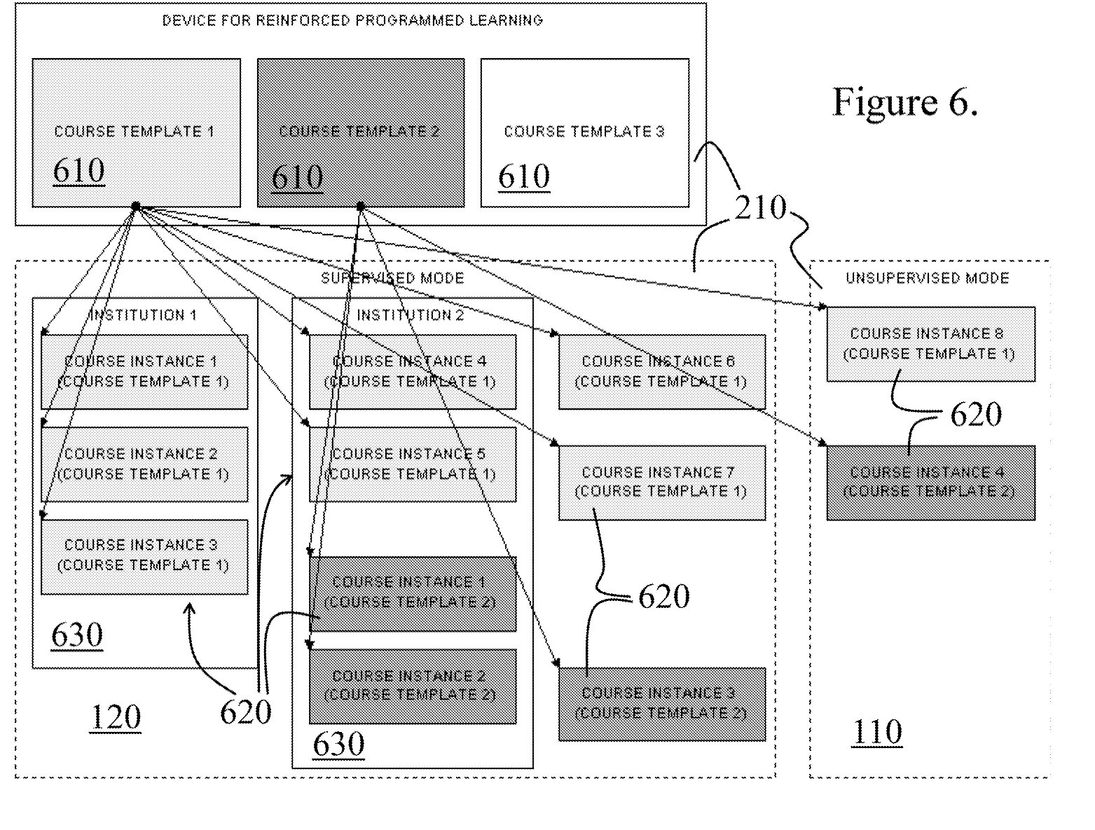

FIG. 6 is an illustration yet another one embodiment in accordance with the current invention.

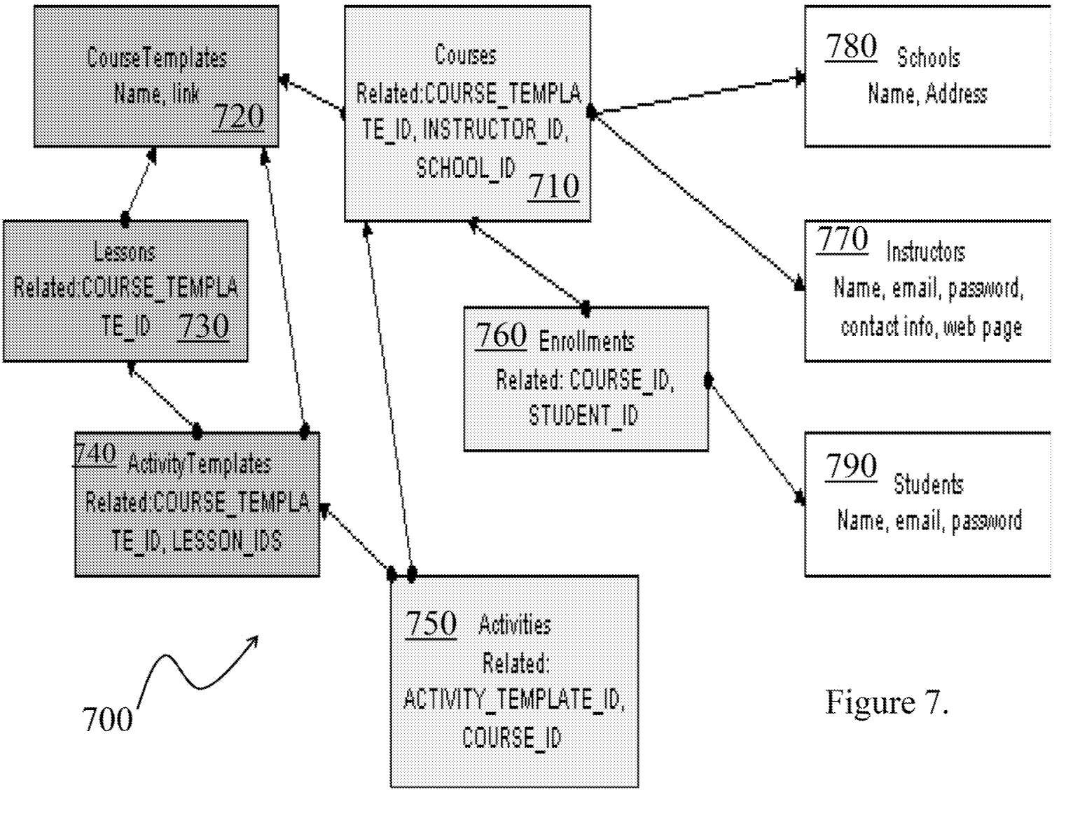

FIG. 7 is an illustration one one embodiment in accordance with the current invention.

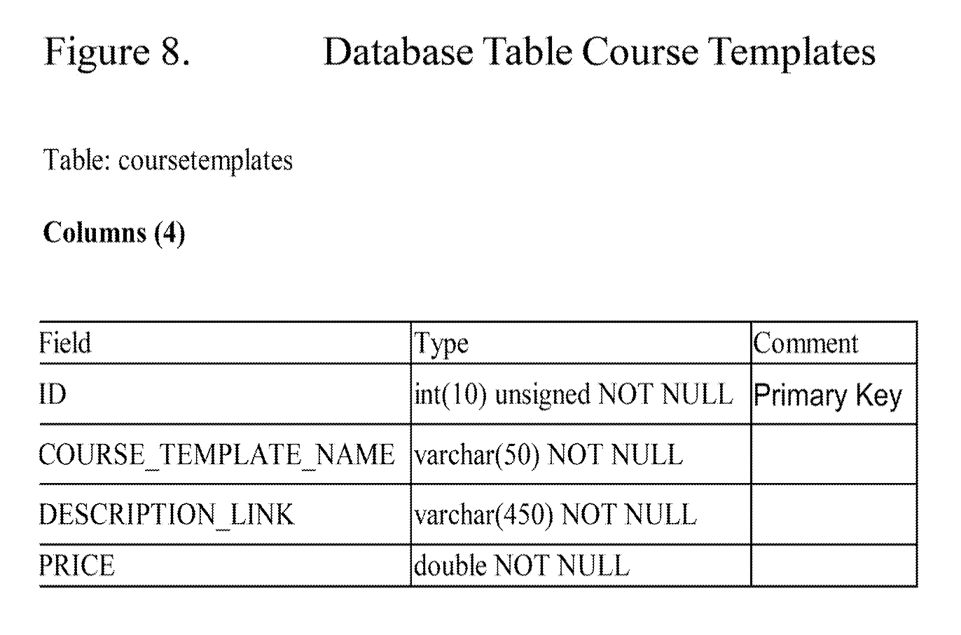

FIG. 8 is an illustration another one embodiment in accordance with the current invention.

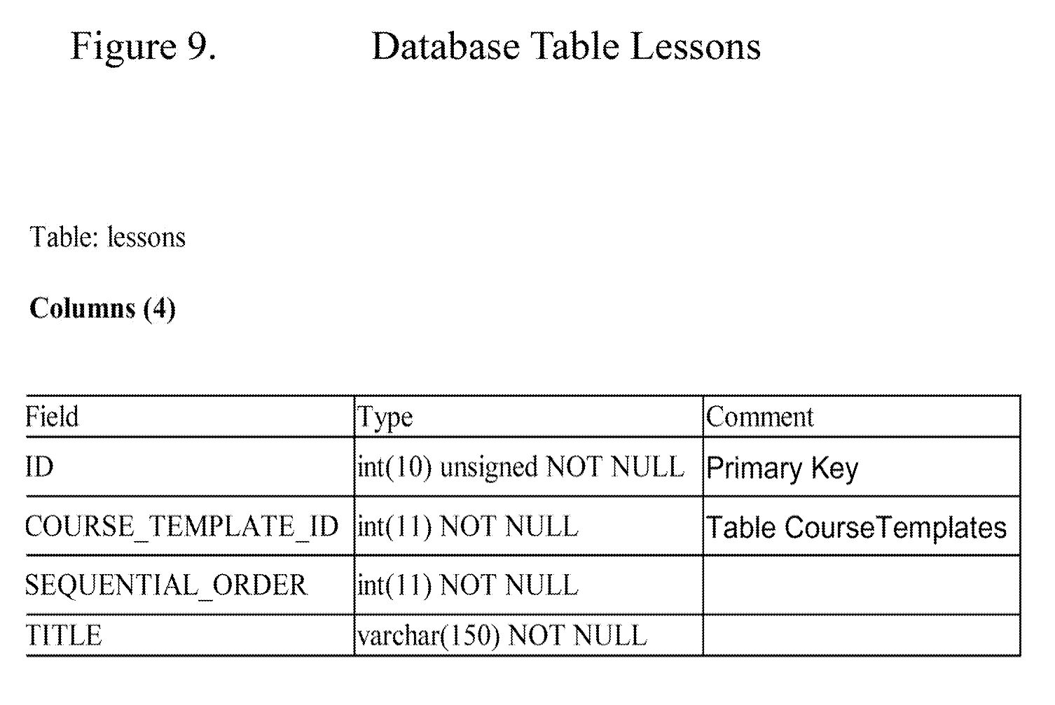

FIG. 9 is an illustration yet another one embodiment in accordance with the current invention.

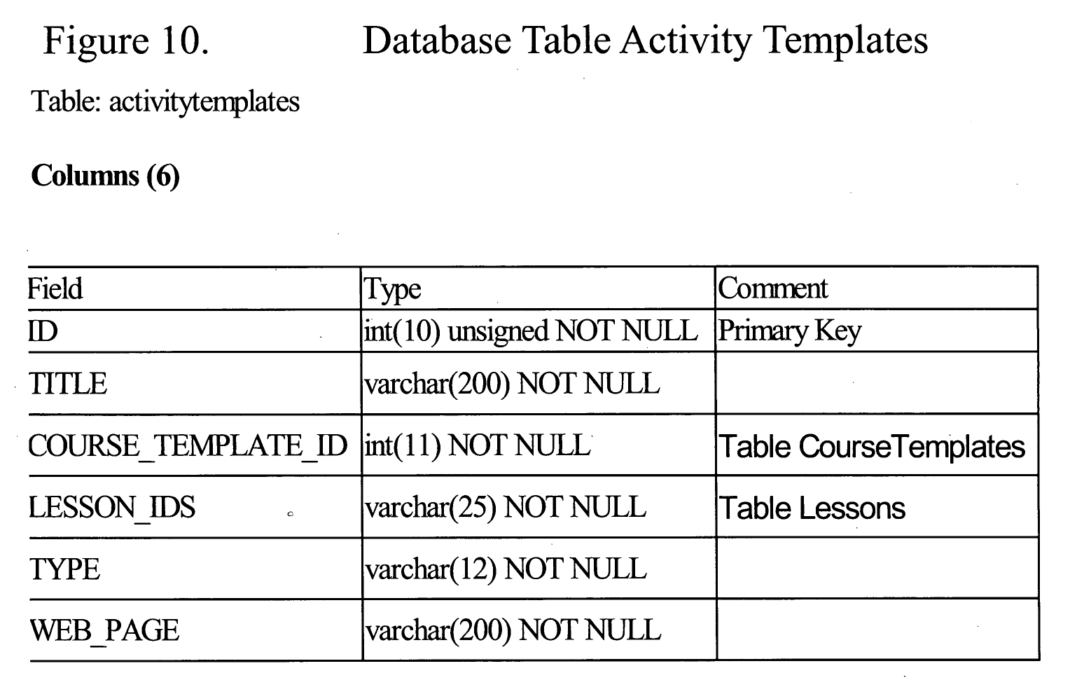

FIG. 10 is an illustration yet another one embodiment in accordance with the current invention.

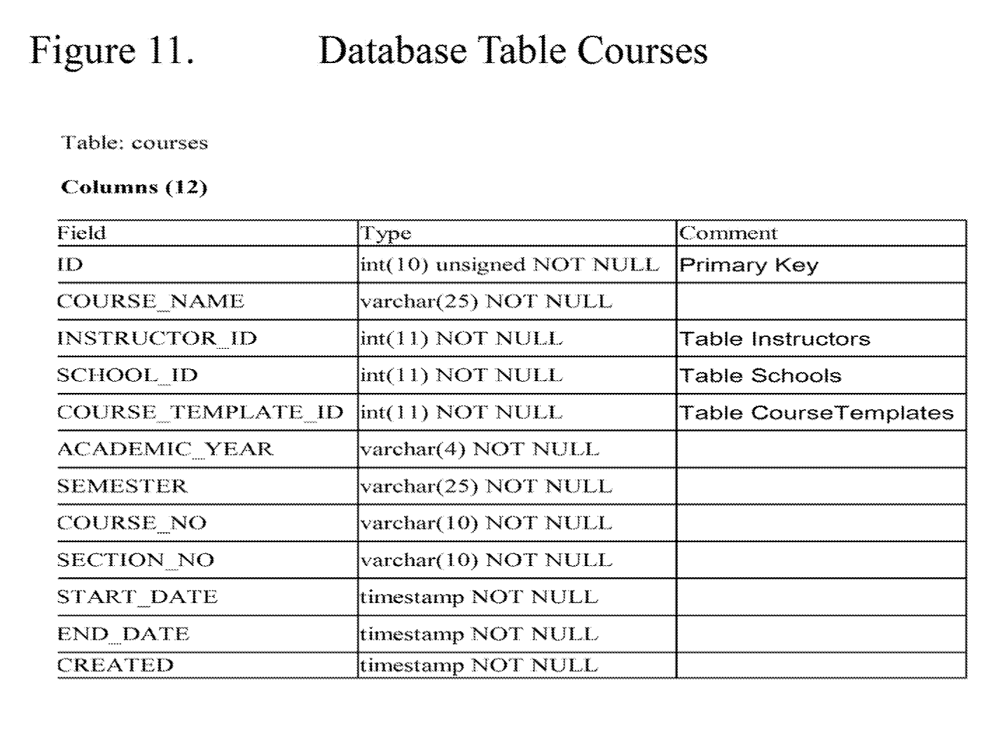

FIG. 11 is an illustration yet another one embodiment in accordance with the current invention.

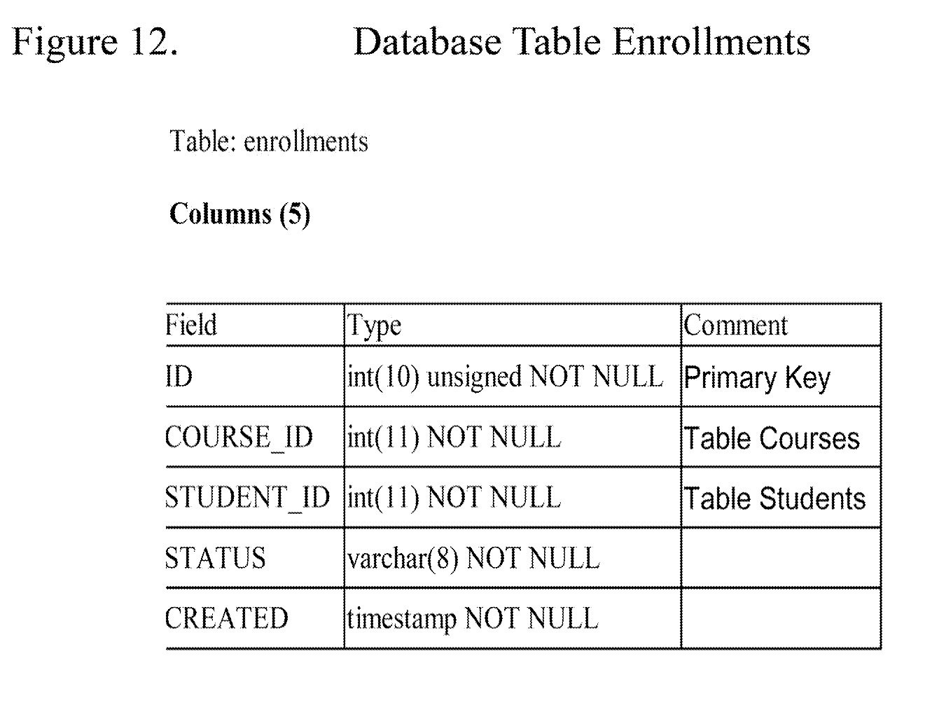

FIG. 12 is an illustration yet another one embodiment in accordance with the current invention.

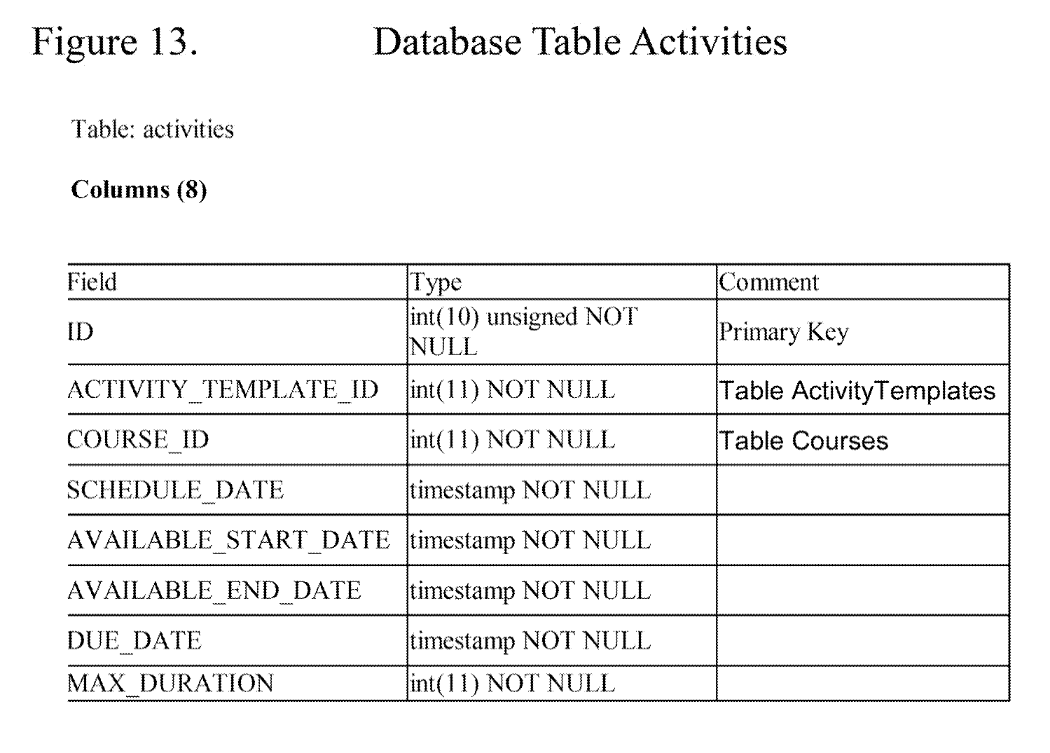

FIG. 13 is an illustration one one embodiment in accordance with the current invention.

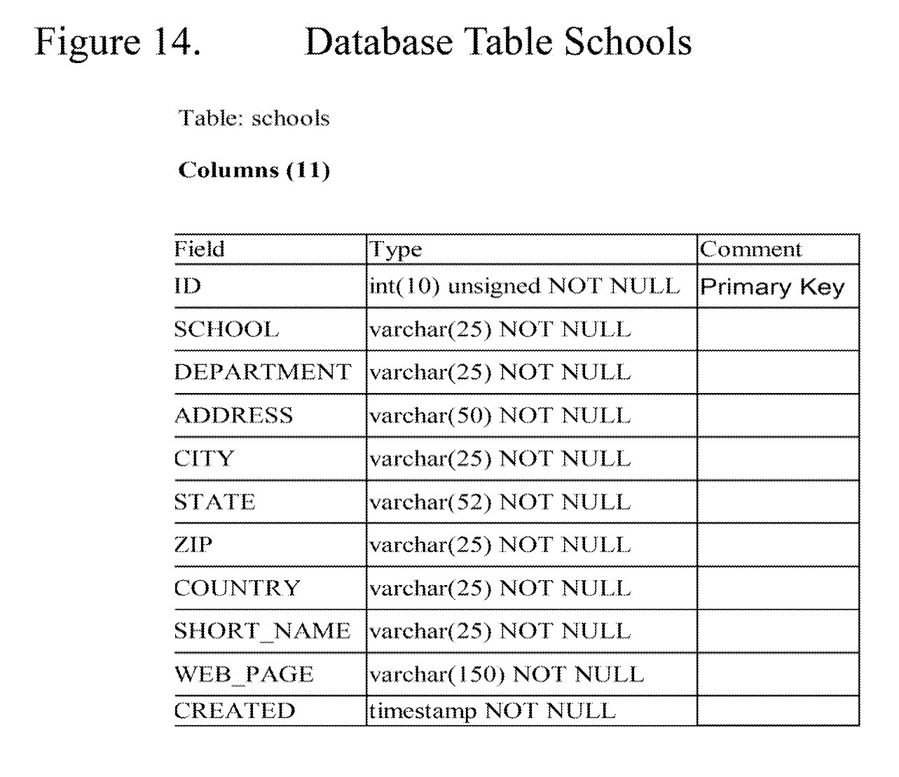

FIG. 14 is an illustration another one embodiment in accordance with the current invention.

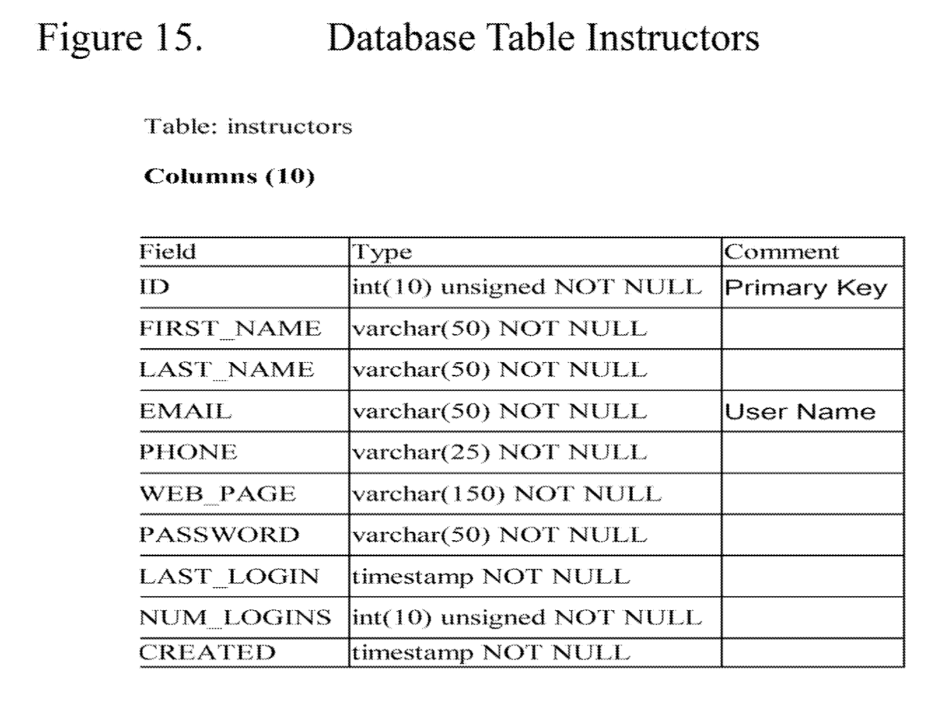

FIG. 15 is an illustration yet another one embodiment in accordance with the current invention.

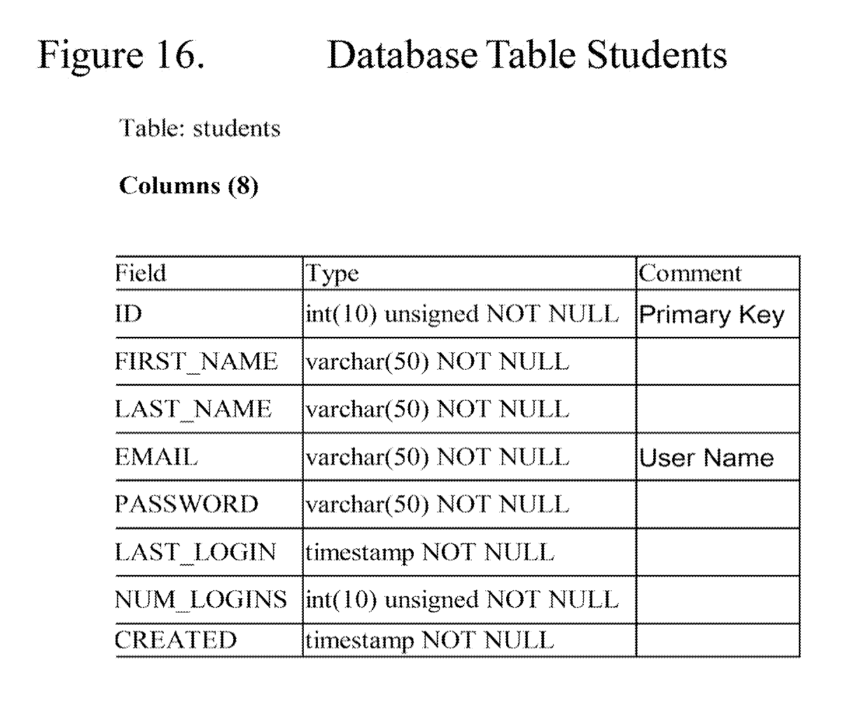

FIG. 16 is an illustration yet another one embodiment in accordance with the current invention.

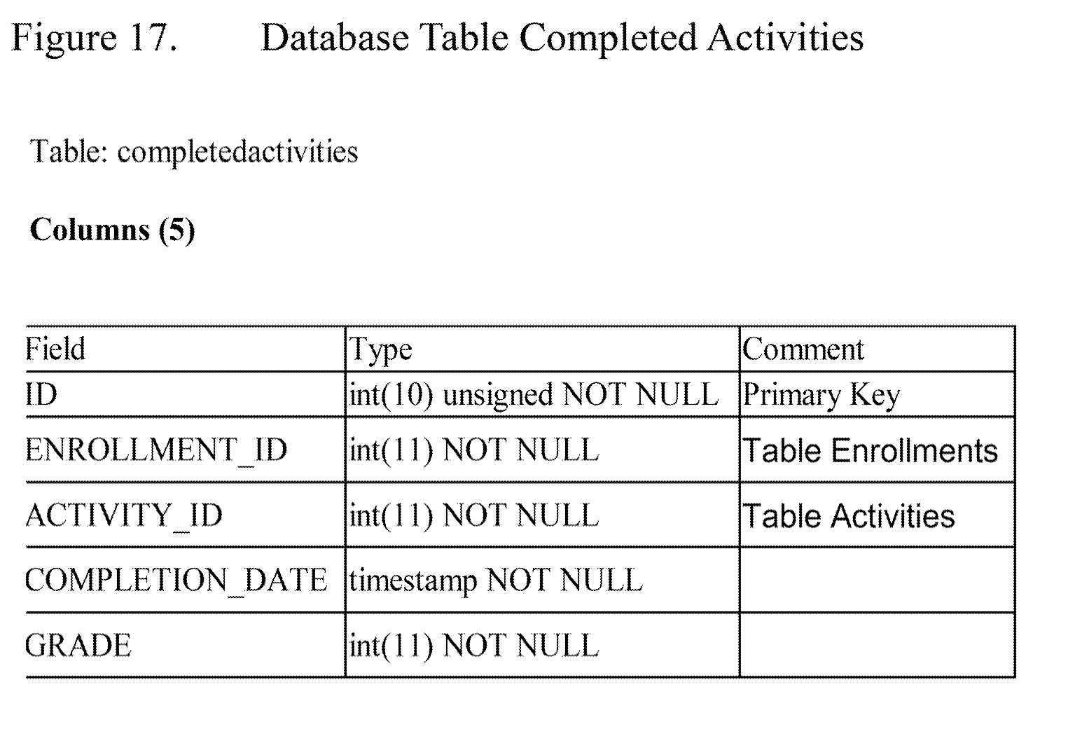

FIG. 17 is an illustration yet another one embodiment in accordance with the current invention.

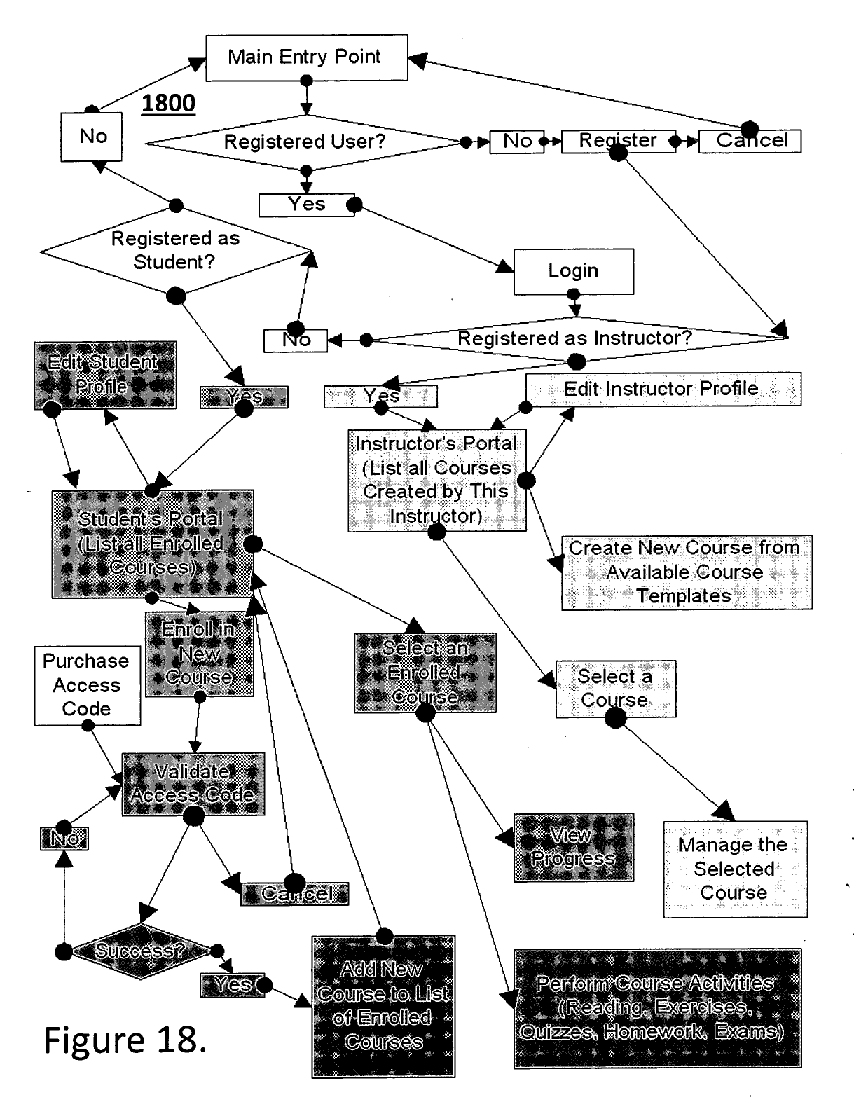

FIG. 18 is an illustration yet another one embodiment in accordance with the current invention.

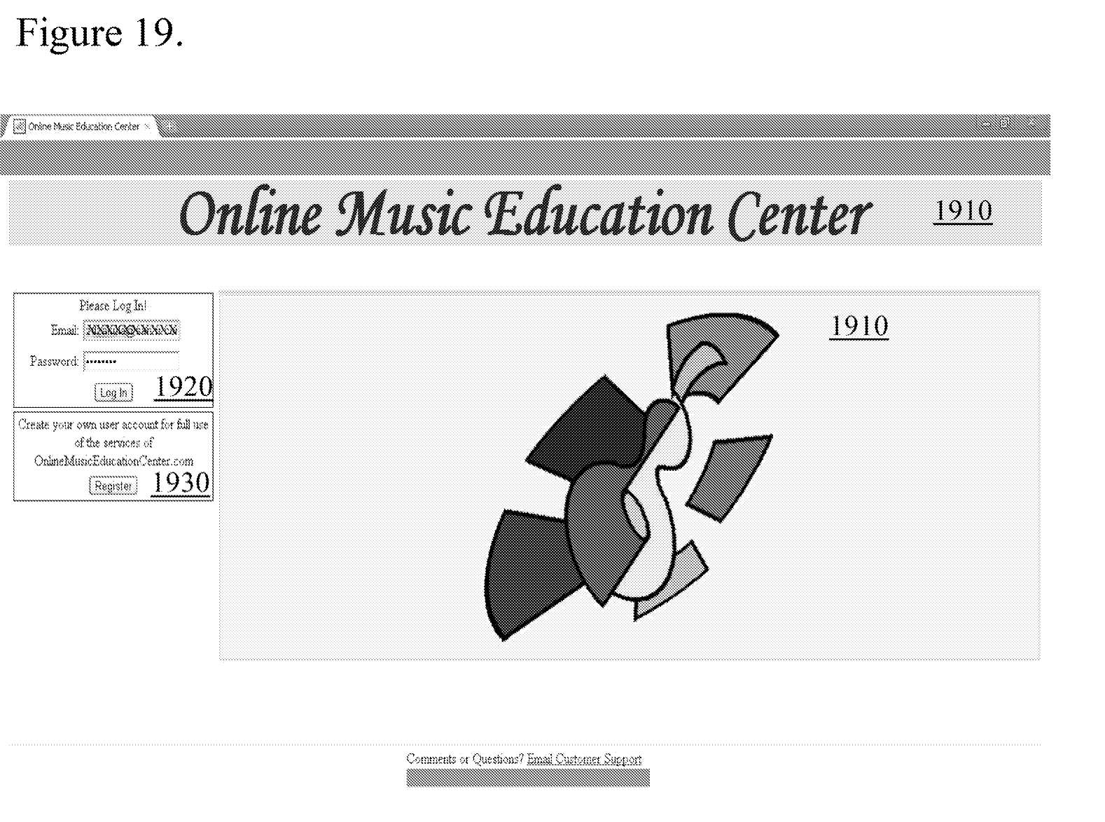

FIG. 19 is an illustration yet another one embodiment in accordance with the current invention.

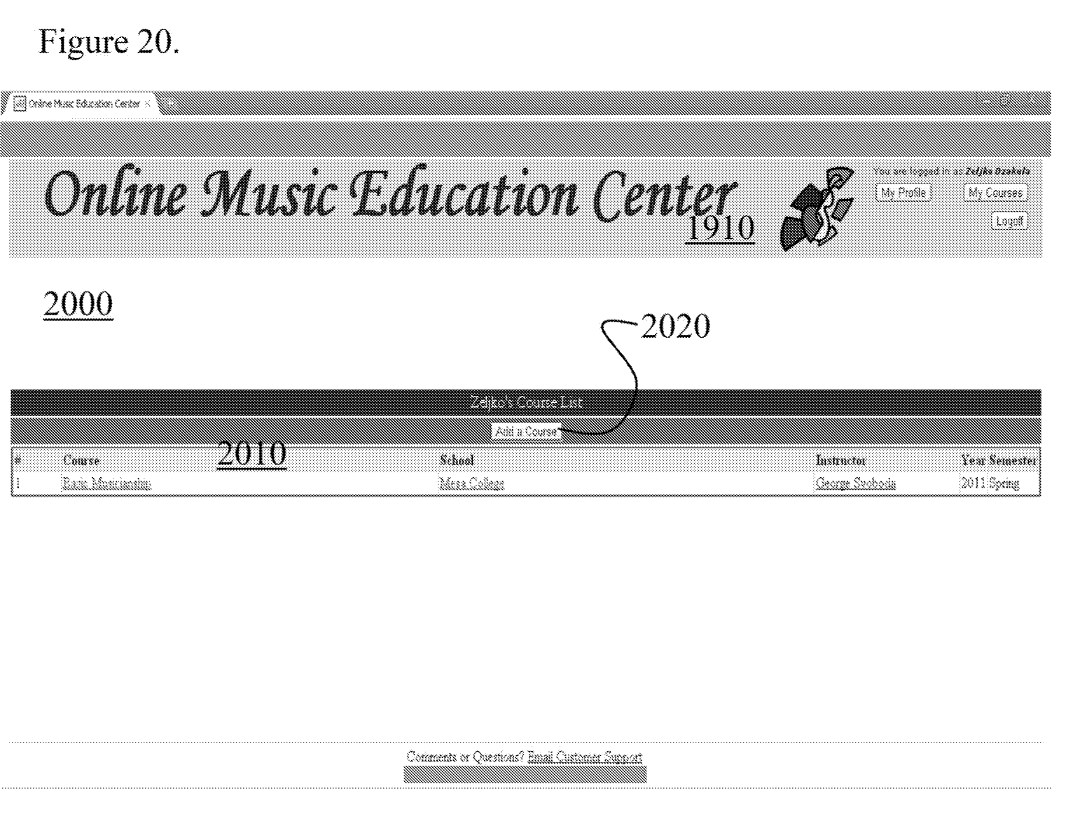

FIG. 20 is an illustration yet another one embodiment in accordance with the current invention.

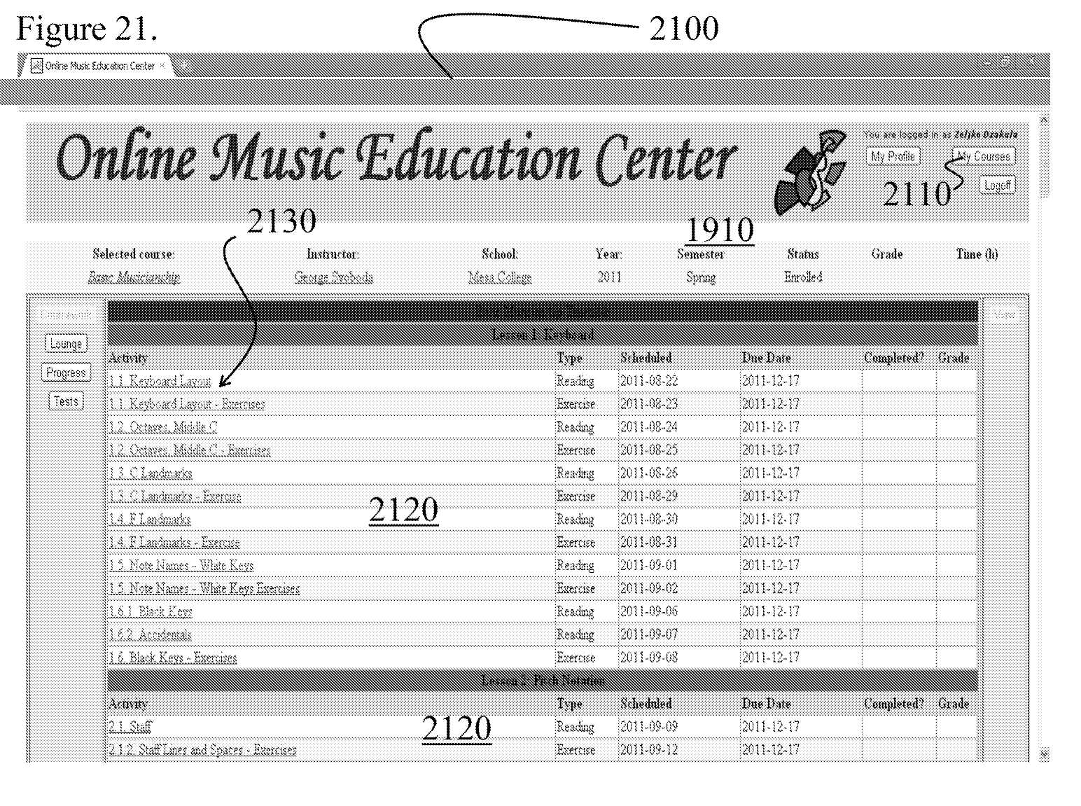

FIG. 21 is an illustration yet another one embodiment in accordance with the current invention.

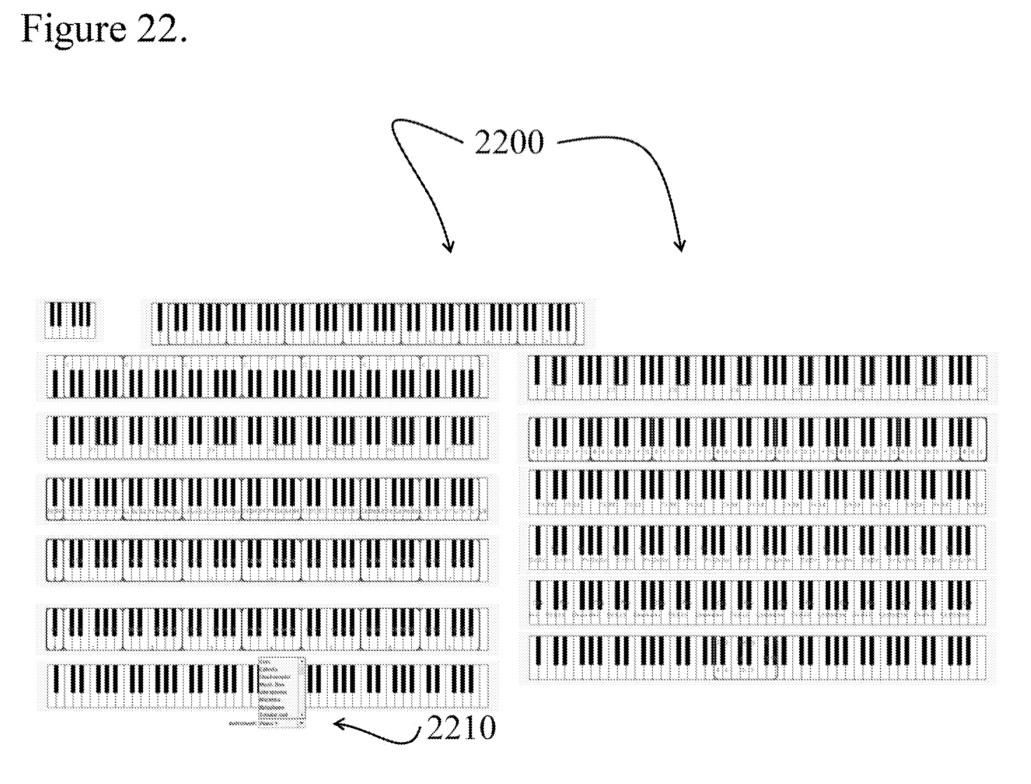

FIG. 22 is an illustration yet another one embodiment in accordance with the current invention.

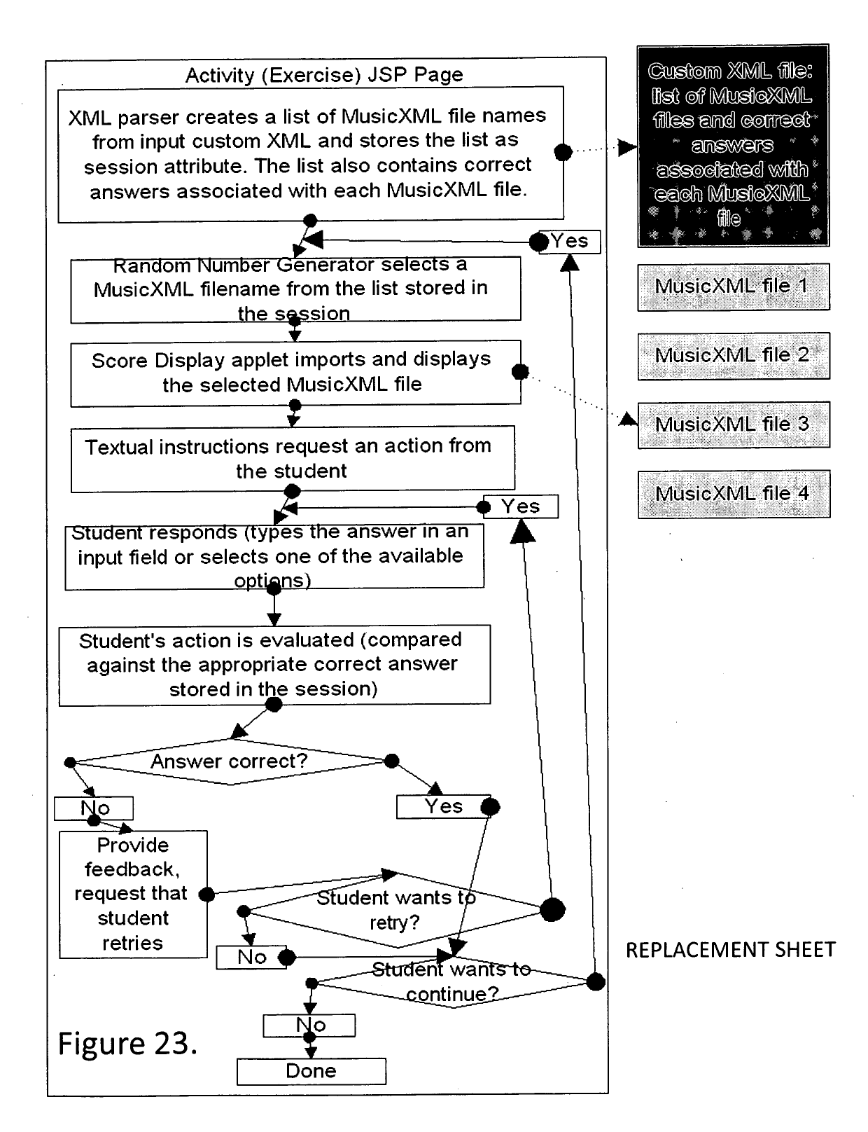

FIG. 23 is an illustration yet another one embodiment in accordance with the current invention.

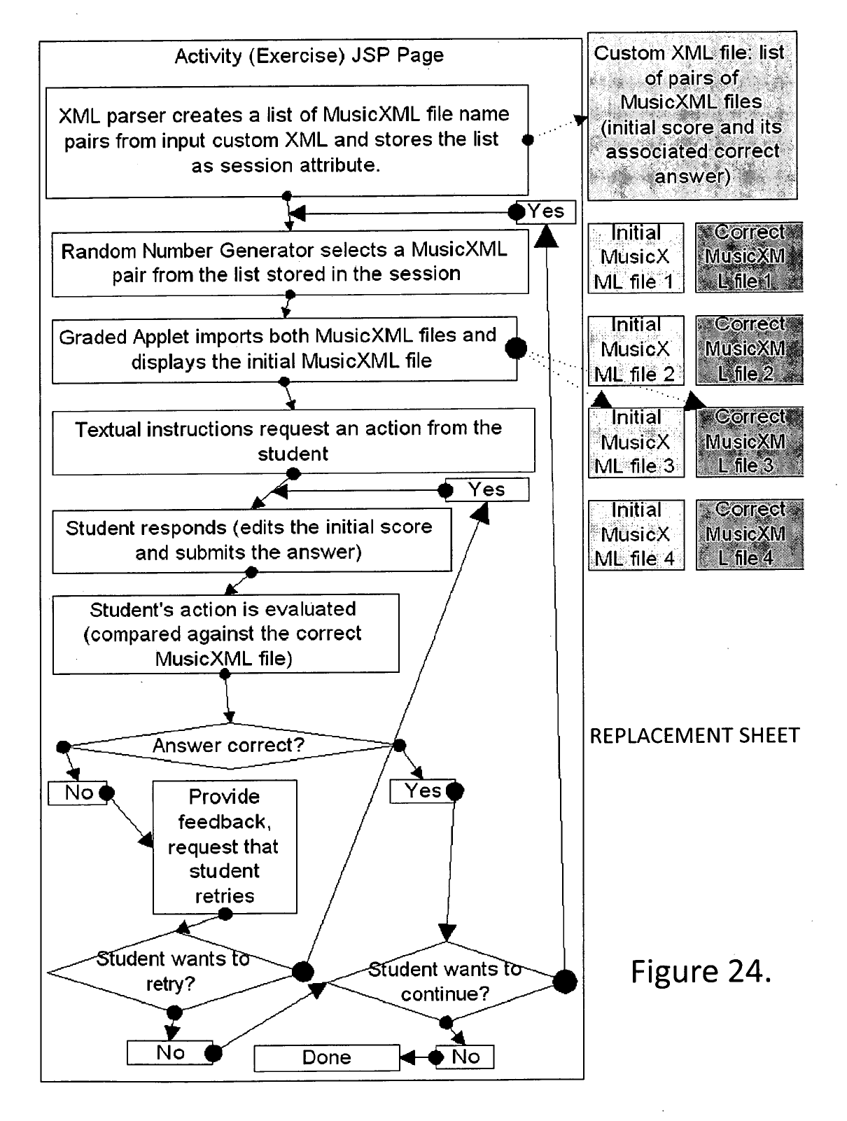

FIG. 24 is an illustration yet another one embodiment in accordance with the current invention.

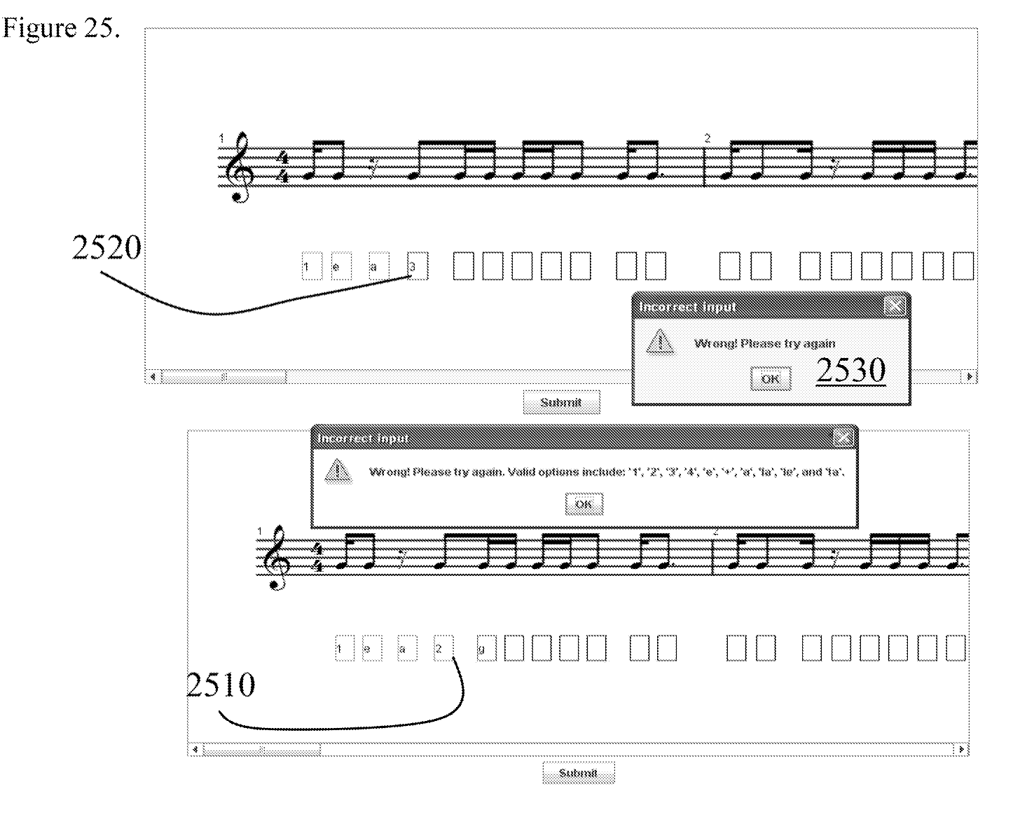

FIG. 25 is an illustration yet another one embodiment in accordance with the current invention.

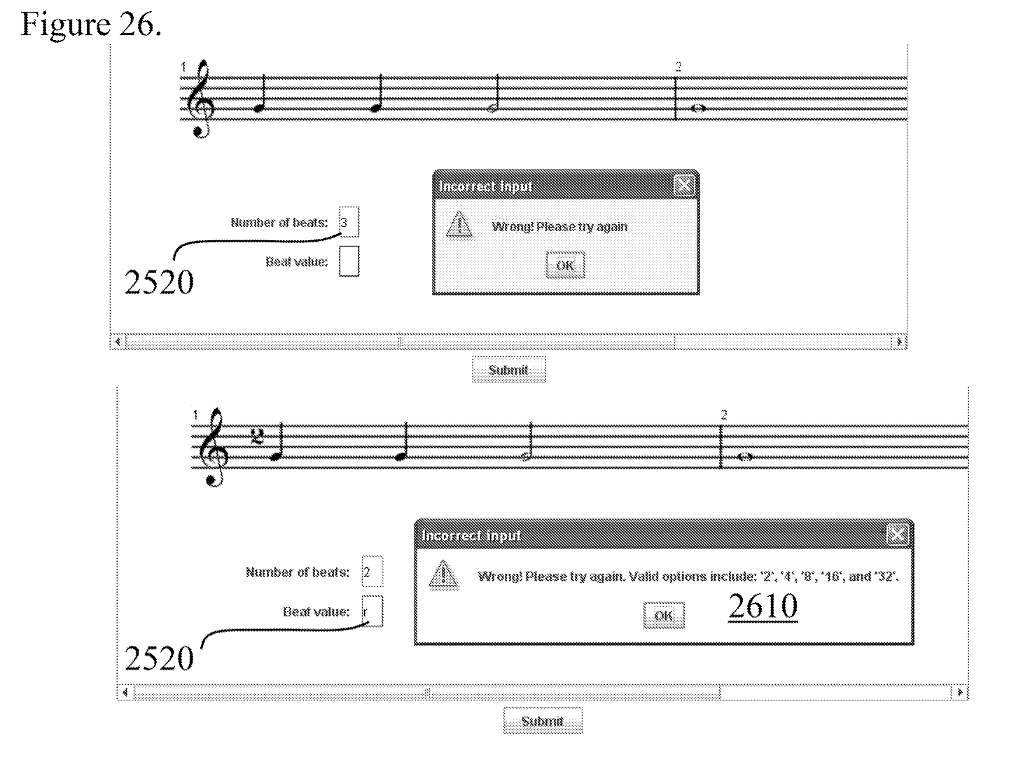

FIG. 26 is an illustration yet another one embodiment in accordance with the current invention.

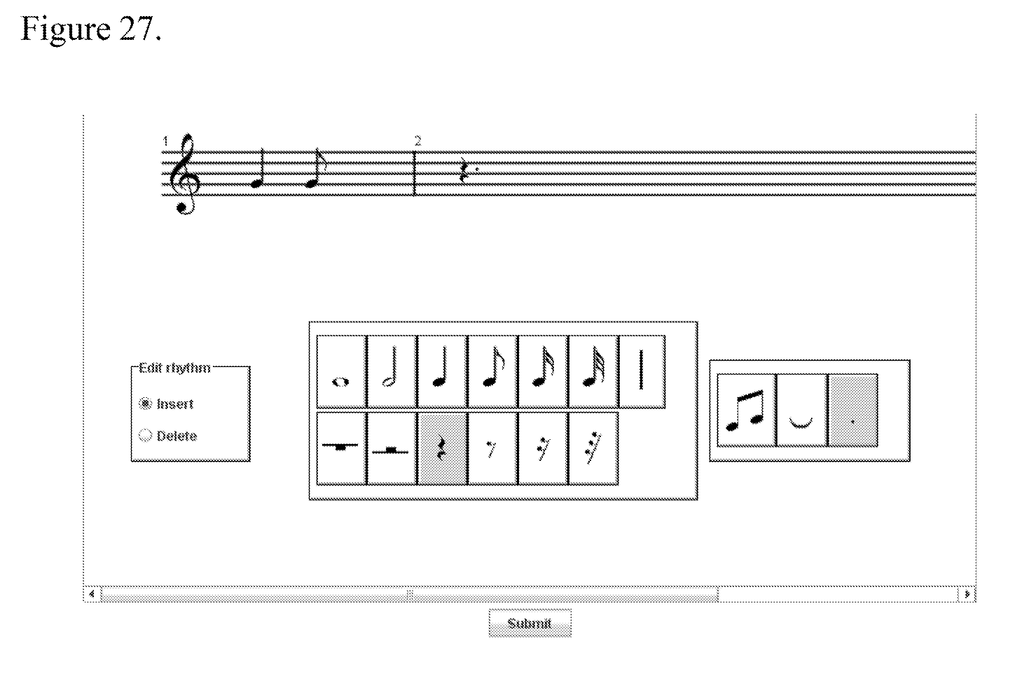

FIG. 27 is an illustration yet another one embodiment in accordance with the current invention.

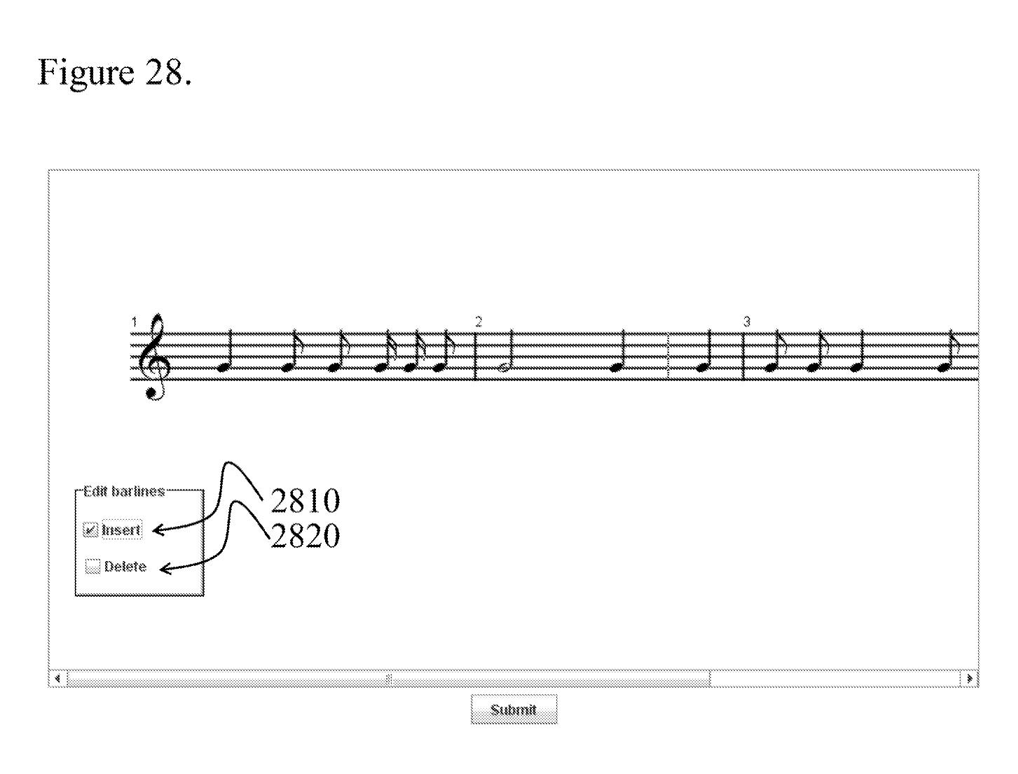

FIG. 28 is an illustration yet another one embodiment in accordance with the current invention.

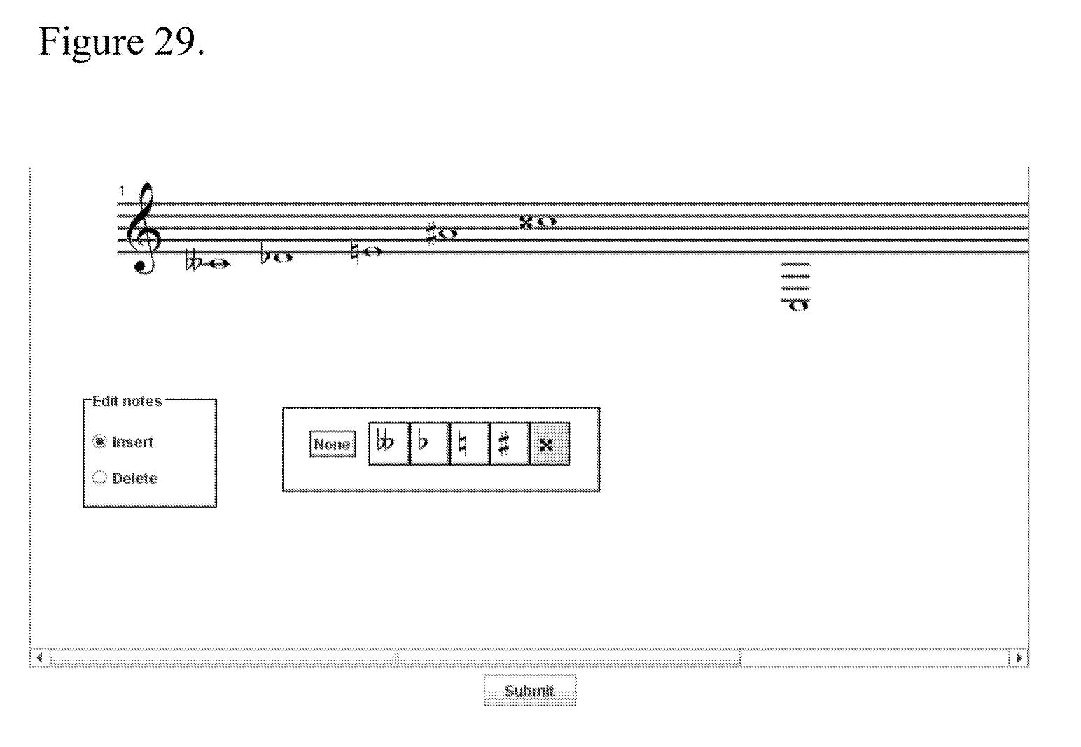

FIG. 29 is an illustration yet another one embodiment in accordance with the current invention.

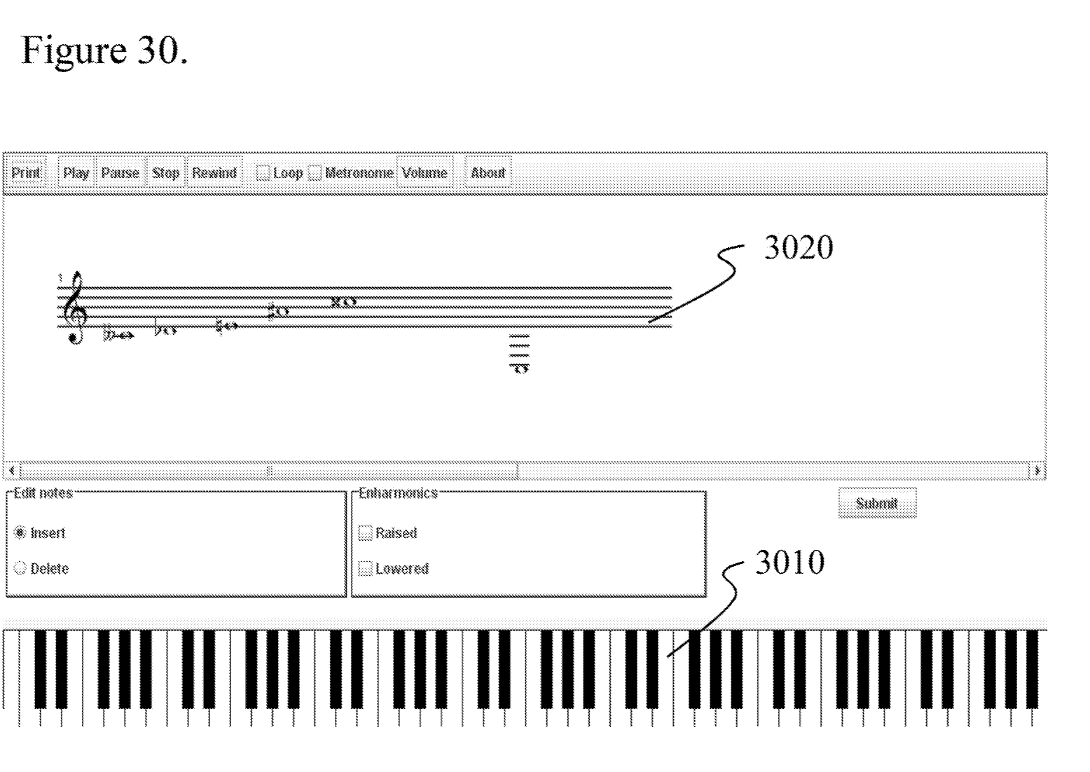

FIG. 30 is an illustration yet another one embodiment in accordance with the current invention.

### DETAILED DESCRIPTION OF THE INVENTION

One particular embodiment of the current invention may incorporate client-side, Java-based technology to support online music theory courses. It consists of a core library and a set of graphical user interface tools, implemented as Java applets. The core library may be responsible for generic tasks, such as file input/output, score display, and midi playback. The applets present musical questions to the student, record the student's answers to the posed question, automatically grade the answer, and store the server-managed database.

Devices and methods in accordance with the current invention for Reinforced Programmed Learning 100 may operate in Unsupervised 110 or Supervised Modes 120, including any mixture of the two (FIG. 1).

In the Unsupervised Mode 110, a device for reinforced learning 210 may interact with one or more students 220(FIG. 2).

In addition, the Supervised Mode 120 may involve participation of one or more instructors 310, either within or outside of an institutional setting. In this mode, the device may interact with, both, the student(s) 220 and/or the instructor(s) 310 (FIG. 3).

In both modes 110 and 120, the device 210 may automatically correct and grades students' work. In the Supervised Mode 120, automated grading may relieve the instructor 310 from burdensome, repetitive tasks. The instructor(s) 310 may be empowered to override the device 210 and modify automatically generated grades.

The device 210 may analyse and summarizes each student's performance, helping the instructor 310 to focus on the student's personalized needs.

Also, the device 210 may analyze and summarize collective performances of groups of students, including but not limited to class, study group, team . . . , directing instructor's focus toward areas that would most benefit the entire groups.

In different embodiments utilizing the Supervised Mode 120, the instructor 310 may also use the device 210 to, for example:
Reorder and reschedule tasks;
Activate/deactivate portions of study material;
Edit or expand study material;
Edit weights given to grades;
Edit penalties for late assignments;
Communicate with students;
Assign supplemental study materials and/or tasks;
Review, grade, and provide feedback on assignments that require human interaction (projects, presentations, essays).

In certain embodiments, the device/method and/or its services may be delivered to the users in any of the following ways or it's combinations:
Software package(s) installed on a central server and made publicly available via the World Wide Web (WWW);
Software package(s) installed on a local server and made internally available within an organization via Intranet;
Cellular phones and other hand-held devices;
Software packages locally installed on users' desktop or laptop computers;

The above stay represent particular examples of the manners in which the device/method and/or its services may be distributed. The invention and its operation are not limited to the media listed above.

In both the Unsupervised and Supervised Modes 110 and 120, the student 220 may establish his/her account with the service provider, including a unique username (for example, email address) and password. The student account may not be sufficient to access learning services. To access and use the services, student 220 my need to purchase access to course(s). In some embodiments, anyone can open student account (s) without any limits, apart from uniqueness of username.

In the Supervised Mode 120, the instructor 310 may establish his/her account with the service provider, including a unique username (for example, email address) and/or password. In other embodiments, instructor accounts may only be created by an administrative entity.

In certain embodiments, the device/method and/or its services may be purchased using or combining any of (but not limited to) the following steps (FIG. 4):
A step 400 including using, for example, a credit card or “PayPal®” to directly establish credentials via the World Wide Web or phone, allowing the access to and use of the device/services (FIG. 4).
A step 500 involving a bookstore or any other physical point of sale that may issue a personal identification code. To access and use the device/services, the user may provide a valid personal identification code (FIG. 5).

A service provider administering the course may generate a set of unique personal identification codes (PIDs). The unique PIDs may be made available for purchase at a physical point-of-sale (FIG. 5). Upon purchasing a PID, the student may provide the PID when registering for the course. The PID provided by the student may be compared to existing, unique, unused PIDs. If a match is found, the registration may successfully completes.

Whether purchasing access from WWW or at a physical point-of-sale, student must have a valid account with the service provider before being able to access and use the services.

When using WWW empowered distribution step 400, student may need to establish valid account with service provider prior to purchasing services. When using physical Point-of-Sale step 500, student may establish valid account after purchasing services.

In certain embodiments, the present invention may be applied to assist learning of, for example, Music Theory, Mathematics, Physics, Biology, Chemistry.

In particular embodiments, toe device 210 may store one or more Course Templates 610. At least one Course Template 610 may provide a blueprint for multiple actual Course Instances 620 potentially associated with one or more Institutions 630 (FIG. 6).

A Course Template may store information shared by several Curse Instances 620 of a given course, which may include but not be limited to:
Reading materials;
Examples;
Exercises;
Homework assignments;
Pool of quiz/exam questions; and
Generic Course Name.

Particular Course Instances 620 may share the same Course Template 610, while potentially differing in”
List of enrolled students;
Modes:
   i. Unsupervised or
   ii. Supervised;
Instructor (if any);
Institution (if any);
Timing:
   i. Semester;
   ii. Start/end dates, total duration;
   iii. Breaks/Holidays;
   iv. Scheduling of specific tasks.

Some Coarse Instances 620 may also differ in administrative details, such as:
Course Number;
Section Number;
Actual Course Name as listed in the institution's catalog;
Course Description (supplied by the instructor/institution); and
Prerequisites.

Other Course Instances 620 may also differ in pertinent additional information associated with the attributes of the given course instance 620, such as (but not limited to):
Instructor's contact information;
Address of the institution;
Customized or additional course materials provided by the instructor;
Customized grading scheme/weights;
Penalties for late submissions.

In some embodiments, the service provider stay use the desired Course Template 610 to instantiate an actual course in either unsupervised 110 or supervised mode 120.

In some embodiments, a registered instructor may use a Course Template 610 to instantiate an actual course in supervised mode 120.

The particular Course Instance 620 of a course may or may not be linked to a particular (e.g. educational) Institution 630.

In a specific class of embodiments, pertinent data may be organised in Relational Database Configuration 700 as schematically indicated in FIG. 7. The Database configuration may include Courses Data 710 including for example pertinent Course Templates IDs, instructors IDs, Institution IDs . . . relationally associated with Cours Template data 720, including Course Template names and link info. Further, the Curse Templates data may be organized in relationship with lessons data 730 pertinent to the particular courses, which in turn may be relationally associated with data on course activities (Activity Templats 740)for particular lessons. It may of interest to aggregate Activity data sets 750 in associations with activity Templates 740 and, in turn, with different Courses info 710.

In addition, an integrated Configuration 700 may conveniently include and relate enrolment data 760, qualified instructors data 770, data 780 pertinent to the Institutions 630 and/or students info 790 (either protected as personal and proprietary and data already in the public domain.

Even more particularly data pertinent the Course Template 610 may include a list of activity templates, having (but not limited to):
Reading assignment templates;
Exercise templates;
Homework assignment templates;
Quit templates; and
Exam templates.

Activity templates may also include or contain (and/or point to) specialized educational material and/or individualized or group related grades, grade statistics, and grading schema/weights.

In significant portion of embodiments, Activity Templates 740 may not contain inherently instance-specific information, such as scheduling or actual grading schema/weights.

An exemplary Course Instance 630 based on a given Course Template 610 may automatically inherit all Activity Templates 740 from its parent Course Template 610. The activities inherited from the Course Temple to 619 may give rise to actual activity instances.

In some embodiments, upon instantiation, an instance of a course is automatically assigned a default schedule for all the activity instances inherited from the course Template 610.

The scheduling mode of a activity instance may be, for example:
Open-ended (no due-dates);
Rigid (student may only submit work prior to due date); and/or
Flexible (full credit given for work submitted prior to due date, grade penalties imposed on late submissions).

In the supervised mode 120, the instructor 310 may edit the scheduling mode and/or actual timing of activity instances. In the unsupervised mode 110, the service provider administering the course may edit the scheduling of activity instances.

In some embodiments, template and/or instance information may be organised using (but not limited to) any of the following (or combination of):
XML files;
ASCII files;
Property files
Application-specific binary files;
Object-oriented database; and
Any other means of structuring course information.

In certain embodiments, the Relation Database may incorporate the fables illustrated in FIGS. 8-17.

In certain embodiments, the workflow 1800 leading to Course Activities may look as shown in FIG. 18.

In some embodiments, the invention may adhere to the Model-View-Controller (MVC) architecture. The Model may store business data in MySQL (or Derby or MS-SQL Server or any other relational database). The Model may also store some data as XML files on the server. Some XML files may be made available to the client. In addition, the Model may use custom-built XML dialects encapsulated in document-type definition (DTD) files. The Model may comprise service Java classes that interact with the database and manipulate the data.

In an example implementation, the Controller is STRUTS 1.3 (Java classes derived from Action accept user inputs from the View, delegate tasks to Model Service classes, and forward the results back to View).

Alternatives to STRUTS 1.3 include, but are not limited to, STRUTS 2.0, SPRING, C# .NET/ASP, or any other MVC-based framework, JSP pages alone, PHP, or any other suitable framework for web-based applications.

The View may comprise JSP pages using standard tag libraries, property resources, and custom-built Java applets. The View also may comprise images, HTML files, and application resources. Alternatives to Java applets as vehicles of student's interaction with the View include but are not limited to Flex/Flash, JavaScript/Canvas, and C++ ActiveX.

Certain embodiments may offer courses in an WWW environment such as web enabled The Musicianship (a 501(c)(3) charitable not-profit organization, www.themusicianship.org; Nov. 27, 2012).

One exemplary WWW embodiment (pertinent to an experimental “Online Musical Education Center” used for developmental purposes only and not available for public “Log In” or inspection as of the current application filing dates login/registration page for an on-line implementation is shown in FIG. 19. It may incorporate one or more product ID fields 1910, at least one interactive “Log In” field 1920, and at least one interactive “Register” field 1930.

Upon successful login, a prospective or current student may be directed to the Student Portal 2000 (FIG. 20). The student's enrollments may be fetched from the database table Enrollments using STUDENT_ID as a key. Student's enrollments may be listed in a table titled Course List 2010. In the Supervised Mode 120, instructors 310 and/or institution 630 (if any) may also be listed. The student 220 may ado a new enrollment using the Add Course button 2020. The action may require a valid PID and, if successful, may update the enrollments data 760 and/or the Curse List 2010.

A click on an enrolled course displays details pertaining to the Selected Enrollment page 2100, shown on FIG. 21 (link to course description, instructor 310, school 780, academic year/semester, status). The button “My Courses” 2110 directs the student 220 back to Student Portal 2000.

While preparing the Selected Enrolment page 2100 for display, the device may collects all activity instances belonging the selected course instance and tabulates there, along with the activity type treading, exercise, homework, quit, exam), scheduling information, grade, and completion status. A click on a particular activity in any of Selected activity portions 2120 takes the student to the particular Selected Activity 2130 by opening pertinent Activity Pages.

Activity Pages may be implemented using JSP (Java Server Pages) and dynamically rendered to HTML by web container. Activity Pages may include:
Textual instructions
Images
Navigational tools
Auxiliary widgets
Any combination of the above

Certain activity pages use active Auxiliary Widgets or plugin elements to:
Enhance study material,
Enable interactive learning activities, and
Automate grading.

For example, the Auxiliary Widgets used for the Music Theory activities may include:
Piano Keyboard,
Fretboard of a fretted instrument, such as guitar, mandolin, ukulele, bouzouki, domra, bandurria, mandola, octave mandolin, mandocello, tambura, prim, bisernica, brac, and other.
Fingering schemes for wind instruments, such as recorder, clarinet, etc.
Interactive diagrams visualizing pitch creation on any musical instrument,
Interactive score display/editing tools,
Widgets derived from the above and their combinations.

An exemplary Keyboard widget including a Midi Keyboard Plugin contained in activity pages has been illustrated in FIG. 22. It may illustrate several features of various keyboard widget instances, including varying ranges, timbres and annotation capabilities. The Keyboard Widget is implemented in Java as an Applet. Mouse clicks on the piano keys play the corresponding pitches. The user can select the desired timbre from among the midi instruments available on the client platform. Annotations (text, frames) 2210 may support textual explanations. Annotations 2210 may be defined in XML files associated with activity pages, allowing for flexibility. Adjustable size, number of keys, and range allow placement of the widget in different page contexts.

Exercises, homework assignments and quiz/exam questions may require from the student to play certain pitch(es) on the keyboard. The requested pitch(es) may have to satisfy certain criteria, such as (but not limited to):
Belong to certain octave,
Represent certain pitch class or letter name,
Represent certain interval above or below a given pitch (or both pitches forming the interval),
Represent certain scale degree in a given scale (or a tetrachord or the entire scale),
Represent certain chord tone in a given chord or an entire chord.

The keyboard widget responds to student's action as follows:
Records the student's action,
Provides feedback (if the keyboard is used within the context of an exercise),
Automatically grades the student's action (in the context of a homework assignment, quiz, or an exam question),
Sends a message to the server to update the student's records in the database (tables CompletedActivities, Timekeeper, and/or Grades).

One significant feature of a class of embodiments of the current invention is its use of MusicXml format for input scores. It facilitates manipulation of students' answers and enables automated, grading. It also facilitates random generation of a large number of drill and exam problems. The Score Display Plugin contained, in activity pages displays musical notation recorded in MusicXML files. The MusicXML input is defined, in the parent JSP pages, allowing flexible selection of inputs appropriate to the current activity. The Score Display Plugin may be implemented, in Java as an Applet.

The Score Display Widget may allow the user to play the score, pause, stop, rewind, loop, activate the metronome, change tempo, change volume. It contains a playback cursor that indicates the current score position and facilitates reading music.

The Score Display Widget may feature Annotations (text, frames) that provide textual explanations and visual clues. The Annotations are defined in XML files associated with the parent activity JSP page, affording significant flexibility in selecting, formatting, and presenting messages.

The Score Display Widget may support dotted notes, accidentals, ledger lines, beams, 8va-signs, repeats, directions, multiple clefs, multiple staves in a system, multiple systems, dynamics, tempo signs, wedges, ties, tuplets, standard and odd-meter time signatures, articulation, lead-sheet chord symbols, Roman numeral analysis, figured bass, annotated non-chord tones, lyrics, and so on.

The Score Display Widget may illustrate musical examples with textual explanations. It is used in exercises/homework/quizzes/exam questions as integral part of task formulations (such as “What is the perfect fifth above the displayed note?”). It represents the base from which score editing widgets are derived.

A client-side set of tools included in several embodiments of the current invention may be grouped in a package called Notable. This package may incorporate a plurality of applets and at least one class library that supports the functioning of the applets. The class library is the underlying engine in charge of common tasks, such as, for example, loading flies and creating sound output. In particular, it may provide (but is not limited to) the following functionality: MusicXml input/output, Midi playback, Midi file export, score display, annotation display, animation, support for playback cursor, playback controls (tempo, volume, looping, repeats, pause/stop/rewind), and score printout. These features may be showcased even in a standalone Notable application.

In some significant embodiments, Notable package may include applets constructed to display a score in a browser window and to allow for playback of the displayed score. It may be related, to the Notable standalone application. In the context of the online music theory course, it may be used to illustrate concepts and to provide examples for student's analysis. It may be also used for textual answers, multiple-choice questions, true/false questions, and drop-down menu questions.

FIG. 23 illustrates Workflow for exemplary exercises using the Score Display Widget.

Exercises, Homework assignments, Quizzes, and Exams share similarities, while exhibiting the following differences. Exercises provide feedback until student's answer is correct. Incorrectly answered questions are repeated. Homework, Quizzes, and Exam questions do not provide any feedback. Questions are not repeated. Exercises can be redone an unlimited number of times. Only the total number of trials exercises and the percentage of correct answers may be stored in the database. Homework, Quizzes, and Exams may also be redone. Only the last or only the highest grade may be stored in the database (according to the teacher's preference).

In addition to music notation, the Notable package of different embodiments may also allow user interaction with a simulated piano keyboard and a simulated guitar fretboard. One basic piano applet may display a piano keyboard and plays tones corresponding to the keys clicked with a mouse. The user can select from a plurality of timbres related to a set of preselected midi instruments.

In other embodiments an advanced keyboard applet may allow the user to enter notes in a music score by selecting keys on the piano keyboard. Facilities for deleting a note and displaying raised or lowered enharmonics may be also provided. When used as a drill, the advanced applet may provide additional feedback to the student. If used as a part of a homework assignment or an exam, this applet may automatically grade the student's input and may send the result to the server to be stored in a database.

The Graded Widget, an example of which is illustrated as a workflow in FIG. 24, may be derived from the Score Display widget (e.g. FIG. 23). It may inherit all playback capabilities from the Score Display widget. One purpose of the Graded Widget may be to facilitate grading of complex scores created or edited by student. The grading mechanism starts by importing two MusicXML files from the server: a MusicXML file for initial display (to be edited by the student), and a MusicXML file containing the expected correct answer. Once the student enters and submits the required answer, the widget compares student's answer with the expected correct answer. Exact match between the student's answer and the reference MusicXML implies that answer is correct. Discrepancies indicate that the student's answer is incorrect. Grading is followed by an appropriate action: feedback (for exercises) or message to the server (for homework, quizzes, and exams). The Graded Widget is the base from which all other score editing widgets are derived.

A CountBeats Applet, an exemplary embodiment of which is provided in FIG. 25, may be derived from Graded Widget (FIG. 24) and may follow a similar workflow as that of the Graded Widget. It may provide textual input fields for each beat in tire score. If the particular applet is used for an exam question, no feedback may be provided before the student submits an answer. If the CountBeats Applet is used for exercises, an immediate feedback may be available. For example, correct answers may be labeled with particularly colored frames 2510, while wrong answers 2520 may be framed in other (“warning”) colors. A message dialog 2530 may inform the student if an incorrect answer has been given. In addition, if the incorrect answer contains invalid options, the student may be served a list of valid options to choose from. At least two levels of beat division may be supported. For triplets, at least two counting systems may foe supported (eg. “la-le-ta” and/or ‘1’-‘2’-‘3’). Once the student submits the answer, the correct answer may be listed along with the student's input.

A TimeSignature Applet (FIG. 26) may be derived from Graded Widget and may follow a workflow related to the workflow of Graded Widget in FIG. 24. In exercises of such embodiments, it may provide nearly real time feedback, with wrong answers particularly framed in “warning” colors. Feedback also may provide hints listing 2610 of allowed values for the number of beats and the beat value. The TimeSignature Applet may allow for the student to enter either the number of beats or the beat value, or both. If both inputs have been required, additional explanation may be provided in the accompanying text to compensate for the ambiguity inherent in degenerate meters.

If the TimeSignature Applet (FIG. 26) may be used for an exam question, no feedback may be provided before the student submits the answer. If the applet is used for exercises, immediate feedback may be available. Depending on particular choice of embodiments, correct answers may be labeled with green frames, while wrong answers may be framed in red. The message dialog boxes may inform the student, when an incorrect answer has been given. In addition, if the incorrect answer contains invalid options, the student may be served a list of valid options to choose from. Sample, compound, and odd meters may be supported, with the beat value ranging from 1/32 to ½Ones the student submits the answer, the correct answer may be listed along with the student's input.

An EditRhythm Applet (FIG. 27) may be structured to test student's knowledge of beaming by the beat, connecting notes with ties across bar lines and between beats, and/or splitting a long note into shorter notes connected with ties to insert bar lines or to beam by the beat. In certain embodiments, the Time Signature fidget only request the number of beats corresponding to the given score, while other embodiments only request the beat value corresponding to the given score.

In some embodiments, the Edit Rhythm Widget (FIG. 27) may be derived from the Graded Widget and may follow a similar workflow as that in FIG. 24. It may enable insertion/deletion of a range of note and rest durations, barlines, beaming by the beat, ties, and dotted notes.

The InsertBarLines Applet (FIG. 28) may be derived from Graded Widget, and may follow a similar workflow as that of Graded Widget in FIG. 24. It may enable insertion 2810 and/or deletion 2820 of barlines corresponding to the given meter. The cursor location may indicates barline insertion position. Time signature may or may not be displayed. The InsertBarLines Applet may ask the student to place bar lines corresponding to the given time signature and given rhythmic notation. Student's answers may be graded and stored in the database.

The InsertNotes Applet (FIG. 23) may be derived from Graded Widget, and may follow a similar workflow as that of Graded Widget in FIG. 24. It may enable insertion/deletion of pitches in any given clef. The Note Insertion Widget may also provide support for accidentals. For simplicity, some embodiments may only support whole note durations. The Insertnotes Applet may allow the student to perform multiple tasks, including tasks as follows:

1. Given a pitch class and, clef, write a note in a given octave
2. Rewrite a given note in different clef
3. Rewrite notes using 8va sign
4. Given a set of notes, write enharmonic equivalents
5. Write in a given interval above or below a given note
6. Given a starting note and a sequence of intervals, write in the pitches
7. Given an interval, write in its inversion
8. Given an interval, write in the compound (+ octave)
9. Reduce compound intervals
10. Given random notes, order them in ascending/descending major/minor (natural/harmonic/melodic) scale
11. Given a key and a scale tone name (supertonic, dominant . . . ), write in the note
12. Enter a given scale with accidentals (without the key signature)
13. Write in a given triad or seventh chord in root position or an inversion. The bass note may be given.
14. Given Roman Numerals; write in chord notes using the correct chord inversion
15. Given a scale degree (supertonic, dominant . . . ), write triads/seventh chords built on those tones
16. Given figured bass, write in the chord notes and the lead sheet symbols
17. Perform a speed test for triads.

In many of the above embodiments, the Applet may automatically grade student's answers and store them in the server-managed database. The widget can be used for a range of exercises, homework assignments, quizzes and exam questions (pitch notation, intervals, scales, chords, and other).

Note Insertion from Keyboard Widget (FIG. 30) may combine Graded and Keyboard widgets. If may be derived from Graded Widget, and may follow a similar workflow as that of Graded Widget in FIG. 24. The Rote Insertion from Keyboard Widget may accepts student's mouse clicks on a piano keyboard 3010, and records the selected pitches on the score display 3020. It supports insertion/deletion of notes and use of accidentals to notate enharmonics. Analogous widgets may represent other instruments (e.g. guitar, mandolin, winds, string instruments, and other).

In addition, aforementioned and/or additional Applets may incorporate features as listed below:

SelectBeat Applet allows the student to select all notes that make up the beat in a measure characterized by a given meter.

KeySignature Applet allows the student to enter key signature. Correct placement and order of accidentals are graded. Treble and bass clefs are supported. Support for alto and tenor clefs is also possible.

ChordInversion Applet allows the student to identify root, quality, inversion, and open/close position of a triad or a seventh chord.

LeadSheetChordSymbol Applet asks the student to identify triads or seventh chords in a 3- or 4-part score. Implied, harmonies in 2-part scores can also be analyzed. Slash notation is used to designate the bass note. Results of the harmonic analysis are graded and stored in the database.

FiguredBass Applet asks the student to realise figured bass or to reduce a 4-part score to the figured bass notation. The results are automatically graded and stored in the database.

RomanNumeral Applet enables the student to perform, functional harmonic analysis of a given piece. The results are graded and stored in the database.

NonChordTone Applet tests the student's knowledge of passing tones (diatonic and chromatic), neighboring tones (diatonic and chromatic), changing tones, appoggiaturas, suspensions, and retardations.

Modes Applet tests the student's knowledge of key signatures for Ionian, Dorian, Phrygian, Lydian, Mixolydian, Aeolian, and Locrian modes, relationships between the different modes, and transitions between them. It can also be used for non-diatonic modes, such as the fifth mode of the harmonic minor scale (Phrygian Dominant mode).

SecondaryDominant Applet tests the student's knowledge of tonicization via secondary dominant triads, secondary dominant seventh chords, and their alterations (+5 and −5).

SecondaryLeadingToneChord Applet tests the student's knowledge of tonicization via secondary leading tone triads and secondary leading tone seventh chords, both half- and fully-diminished.

TonicizingChordGroup Applet tests the student's knowledge of complex tonicization techniques, such as (iio-V)/ii, (iio-V)/iii, (ii-V)/IV, (ii-V)/N, and (iio-V)/vi.

TritoneSubstitution Applet tests the student's knowledge of tritone substitution.

BorrowedHarmony Applet tests the student's knowledge of modal borrowing between parallel modes.

ChromaticThird Applet tests the student's knowledge of chromatic third harmonies (lowered III, III, lowered VI, and VI).

PivotChordModulation Applet enables graded harmonic analysis of a score that modulates using a pivot chord.

BaroqueFieldOfSix Applet tests the student's knowledge of the most frequently encountered modulations (within the immediate neighborhood on the Circle of Fifths).

ChromaticModulation Applet tests the student's knowledge of the advanced modulation techniques, such, as the use of secondary leading tone fully diminished chords or the use of German Augmented Sixth as a dominant.

Cadence Applet tests the student's knowledge of imperfect authentic cadence, perfect authentic cadence, plagal cadence, half cadence, Phrygian half cadence, and deceptive cadence.

Neapolitan Applet enables the student to identify or construct Neapolitan altered predominant harmonies.

AugmentedSixth Applet tests the student's knowledge of Italian, French, and German augmented sixth altered predominant harmonies.

CircleOfFifthsApplet test the student's knowledge of the circle of fifths. Additional uses for this widget include major key signatures, minor key signatures, determination of modes with given key signatures, construction of harmonic progressions, or identification of the Baroque field, of six.

Additional components may include GroundBass Applet, ScalarMotion Applet, TonicDominantAxis Applet, LargeScaleArppeggiation Applet, as well as tools for analysis of 20^{th} century techniques (Q4 and Q5 harmonies, pentatonic scales, augmented and diminished scales, polyrhythm, polytonality, pandiatonicism, and serial techniques, in particular pitch classes and the use of tone rows using matrix methods.

An additional advantage of the Score Display widgets is its playback capability. In addition to visually enhancing the learning experience, the Music Theory embodiment also reinforces learning by making it possible to immediately hear the notated music by playing the MusicXML files. Unlike other interactive learning applications, where sound is only played from recordings or midi files and does not emphasize specific locations in the score, the present invention takes advantage of MusicXML and applies playback to scores. The immediate connections between visual (keyboard/guitar fredbord), aural (sound), and symbolic (notation) stimuli revolutionize learning of music theory.

The present invention has been described with references to the above exemplary embodiments. While specific values, relationships, materials and steps have been set forth for purpose of describing concepts of the invention, it will be appreciated by persons skilled in the art that numerous variations and/or modifications may be made to the invention as shown in the specific embodiments without departing from the spirit or scope of the basic concepts and operating principles of the invention as broadly described. It should be recognized that, in the light of the above teachings, those skilled in the art can modify those specifics without departing from the invention taught herein. Having now fully set forth the preferred embodiments and certain modifications of the concept underlying the present invention, various other embodiments as well as certain variations and modifications of the embodiments herein shown and described will obviously occur to those skilled in the art upon becoming familiar with such underlying concept. It is intended to include all such modifications, alternatives and other embodiments insofar as they come within the scope of the appended claims or equivalents thereof. It should be understood, therefore, that the invention may be practiced otherwise than as specifically set forth herein. Consequently, the present embodiments are to be considered in all respects as illustrative and not restrictive.

We claim:

1. A method for reinforced programmed learning to enhance human acquisition of knowledge and skills comprising:
a) providing an electronic device for reinforced learning arranged for electronic interaction with at least one student,
b) on the electronic device for reinforced learning, providing at least one database including at least one course template of preselected education information organized for at least partial retrieval in accordance with at least one prearranged course instance,
c) providing an access information arranged to enable the electronic interaction between the electronic device for reinforced learning and the at least one student and storing information pertinent to the at least one student such that the at least one student may select the at least one of prearranged course instances and participate in interactive processing of the preselected education information,
d) presenting at least one predetermined course instance specific activity to the at least one student and recording the at least one student responsive input into the electronic device for reinforced learning,
e) generating and storing at least one evaluation of the at least one student responsive input at least on a basis of the at least one student response input, the information pertinent to the at least one student, and the preselected education information.
f) communicating the at least one evaluation to the at least one student, providing additional evaluation reinforcing information and proceeding to the step d) until the at least one student opts to proceed to an additional activity or decides to terminate the interactive processing of the preselected education information,
g) processing the at least one stored evaluation and generating at least one grade pertinent to the participation of at least one student, and to assist the at least one student in selection of additional prearranged curse instances.

2. The method for reinforced programmed learning of claim 1, wherein the electronic device for reinforced learning have been arranged and programmed include a choice of interacting with at least one student in an unsupervised mode of operation having no interaction with at least one instructor or in an supervised mode of operation requiring a real time or subsequent supervision and control input of at least one instructor.

3. The method for reinforced programmed learning of claim 1, wherein the programmed learning to enhance human acquisition of knowledge and skills includes knowledge of music and music-related skills, while the at least one course template of preselected education information includes information pertaining to art of music.

4. The method for reinforced programmed learning of claim 3, wherein the access information arranged to enable the electronic interaction between the electronic device for reinforced learning and the at least one student is distributed by accessing at least one on-line point of sale site.

5. The method for reinforced programmed learning of claim 3, wherein the electronic interaction between the electronic device for reinforced learning and the at least one student is arranged using WWW enabled on-line connections.

6. The method for reinforced programmed learning of claim 3, wherein the electronic device for reinforced learning is chosen to operate in the supervised mode and the supervision end control input of at least one instructor utilizes WWW enabled on-line connections.

7. The method for reinforced programmed learning of claim 3, wherein the at least one database has a relational database configuration at least including courses data, course templates IDs, instructors IDs, Institution IDs, and course template data having course template names and link info.

8. The method for reinforced programmed learning of claim 7, wherein the curse templates data have be organised in relationship with lessons data pertinent to the at least one course instance, and relationally associated with data on at least one course instance specific activity.

9. The method for reinforced programmed learning of claim 3, wherein the at least one predetermined course instance specific activity includes activities or activity sequences chosen from a set consisting of answering questions, conducting exercises, preparing homework assignments, participating in quizzes and taking exams.

10. The method for reinforced programmed learning of claim 3, wherein the at least one student responsive input includes input chosen from a set consisting of playing a tone on a keyboard or a freeboard, counting beats, determining number of beats and beat values, beaming by beats, connecting notes with ties across bar line, playing required pitch, inserting notes, inserting notes from keyboard, inserting bars, and editing rhythms.

11. The method for reinforced programmed learning of claim 3, wherein the wherein the at least one student responsive input includes input includes a command from a set consisting of request to play a score, pause, stop, rewind, loop, activate the metronome, change tempo, and change volume.

12. The method for reinforced programmed learning of claim 3, wherein the additional evaluation reinforcing information includes information chosen from a set consisting of: dotted notes, accidentals, ledger lines, beams, 8va-signs, repeats, directions, multiple clefs, multiple staves in a system, multiple systems, dynamics, tempo signs, wedges, ties, tuplets, standard and odd-meter time signatures, articulation, lead-sheet chord symbols, Roman numeral analysis, figured bass, annotated non-chord tones, and lyrics.

13. The method for reinforced programmed learning of claim 10, wherein the inserting note input further includes input forms chosen from a set consisting of: given a pitch class and clef, writing a note in a given octave; rewrite a given note in different clef; rewriting notes using 8va sign; given a set of notes, writing enharmonic equivalents; writing in a given interval above or below a given note; given a starting note and a sequence of intervals, writing in the pitches; given an interval, writing in its inversion; given an interval, write in the compound+octave; reducing compound intervals; Given random notes, ordering them in ascending/descending major/minor (natural/harmonic/melodic) scale; given a key and a scale tone name, writing in the note; entering a given scale with accidentals without the key signature; writing in a given triad or seventh chord in root position or an inversion; given Roman Numerals, writing in chord notes using the correct chord inversion; given a scale degree, writing triads/seventh chords built on those tones; given figured bass, writing in the chord notes and the lead sheet symbols; and performing a speed test for triads.

14. The method for reinforced programmed learning of claim 3, wherein the additional evaluation reinforcing information includes a playback applied to scores arranged for substantially immediate connections between visual, aural, and symbolic stimuli the to at least one student.
